(19) United States
(12) Patent Application Publication
(10) Pub. No.: US 2014/0161018 A1
(43) Pub. Date: Jun. 12, 2014

(54) MULTI-USER MIMO VIA FREQUENCY RE-USE IN SMART ANTENNAS

(71) Applicants: Donald C.D. Chang, (US); Juo-Yu Lee, Camarillo, CA (US)

(72) Inventors: Donald C.D. Chang, Thousand Oaks, CA (US); Juo-Yu Lee, Camarillo, CA (US)

(21) Appl. No.: 14/182,665

(22) Filed: Feb. 18, 2014

(51) Int. Cl. H04W 72/00; H04B 7/04

(52) U.S. Cl. CPC H04W 72/005; H04B 7/0452; H04B 7/0408
USPC 370/312

(57) ABSTRACT

Embodiments of a mobile communications system to service multiple users over same spectrum in a coordinated multi-user communication network and method are generally described herein. The serving signals for transmission to user equipment (UE) in spoke-and-hub configurations will utilize composited transfer functions (CTF) selected and characterized based on channel state information (CSI), which comprises of responses from probing signal sequences for multipath dominated propagation channels in accordance with a dynamic user distribution. A composited transfer functions (CTF) is a point-to-multipoint transfer function and is constructed by combining multiple point-to-point transfer functions. The combining and shaping are via beam forming optimizations in transmitters to be “user dependent” with enhanced responses to a selected user and suppressed responses to other users. The composited transfer functions (CTFs) are constrained by desired performance criteria, not as functions of directions in angles, but as functions indexed by user elements identifications in UE. These are referred as user indexed constraints. When operating in coordination modes, more UEs will be operational concurrently with suppressed interferences intended for other UE using the same frequency resources. The criteria for shaping the composited transfer functions may include those in many beam-shaping techniques, such as orthogonal beams (OB), quiet-zones, and others.

### RELATED APPLICATION

This application claims priority to U.S. provisional application No. 61/908,653, filed on Nov. 25, 2013, which is incorporated herein by reference in its entirety. Present invention relates to multiple-user multiple-input-multiple-output (MU MIMO) communications systems. It is also related to wavefront multiplexing/de-multiplexing (WF muxing/demuxing) technologies.

### TECHNICAL FIELD

The present invention relates to multiple-user multiple-input-multiple-output (MU MIMO) communications systems. It is also related to wavefront multiplexing/de-multiplexing (WF muxing/demuxing) technologies.

This disclosure describes exemplary embodiments on improving the operation and use of MIMO communication methods and systems for multiple users to re-use same spectrum such as through channel state information (CSI) to form user-selecting and/or rejection processing in transmission side. Embodiments pertain to wireless communications. The serving signals for transmission to user equipment (UE) will utilize composited transfer functions (CTF) selected and characterized based on channel state information (CSI), which comprises of responses from probing signal sequences for multipath dominated propagation channels in accordance with a dynamic user distribution. The composited transfer functions (CTF) are constructed or shaped to be “user dependent” with enhanced favorable responses to a selected user and suppressed ones for other users. When operating in coordination mode, more cooperating UEs are configured to suppress interference to other UE using the same frequency resources. Optimization methods for the composited transfer functions (CTF) based on selected criteria are presented.

The composited transfer functions (CTFs) are constrained by desired performance criteria, not as functions of directions in angles, but as functions indexed by user elements identifications in UE. These are referred as user indexed constraints. CTFs are combined results from (1) dynamic beam forming networks (BFNs) for shaped beams and (2) time-varying propagation effects via a multipath dominant communication channel, where outcomes from the BFNs are known and controllable and effects of multipath propagations are not controllable but measurable from various sources to different destinations. The measurements on propagations are pair by pair in space and thus featuring discrete spatial samples. Our interested parameters are limited to locations with measurable capability such as transmitting sites and destinations for receiving.

Some embodiments relate to coordinated point-to-multipoint (p-to-mp) communication in spoke-and hub configurations. The criteria for shaping the composited transfer functions (CTF) for a transmitter in a communications hub may include be identical or similar to those in many beam-shaping techniques, such as orthogonal beams (OB), quiet-zones, and others. Some embodiments relate to wavefront multiplexing (WF muxing)/demultiplexing (demuxing) as means for coordinated or organized concurrent propagations through multipath dominated channels. As a result, methods for calibrations and equalizations among multiple path propagations become possible. Some are through forward paths only. Consequently, implementations of techniques on coherent power combining in receivers for enhanced signal-to-noise ratios (SNR) are simple and cost effective.

### BACKGROUND

A wireless communication using multiple-input multiple-output (MIMO) systems enables increased spectral efficiency for a given total transmitting power. Increased capacity is achieved by introducing additional spatial channels in multipath dominated propagation environment, which are exploited by various techniques such as spatial multiplexing, space-time (Block) coding and others as a part of pre-processing to maximize isolations among these parallel channels. Many MIMO systems feature enhanced spectral efficiency for single users. A single user MIMO features a single multi-antenna transmitter communicating with a single multi-antenna receiver. Given a MIMO channel, duplex method and a transmission bandwidth, a system can be categorized according to (1) flat or frequency selective fading, and/or (2) with full, limited, or without transmitter channel state information (CSI).

In contrast, a multi-user MIMO (MU-MIMO) design usually features a set of advanced MIMO (multiple-input and multiple-output) technologies where available frequency spectrums are re-used and spread over a multitude of independent access points and independent radio terminals—each having one or multiple antennas or antenna elements. To enhance the communication capabilities of all terminals, a MU-MIMO applies an extended version of space-division multiple access (SDMA) to allow multiple transmitters to send separate signals and multiple receivers to receive separate signals simultaneously in the same band. There have been many MIMO-OFDM systems for multiple user applications. Different users will use various sets of distribution patterns over the same bandwidth over which orthogonal frequency components are radiated.

In this invention, our techniques exploit two aspects of propagation channels for multiple user MIMO systems: (1) “shaping” MIMO channel transfer functions based on available channel state information (CSI) at transmission side, and (2) applying wavefront (WF) multiplexing to efficiently sharing power and bandwidth among multiple users. Since a channel “transfer function” is originated from a linear combination of multiple transmitting elements on a MIMO transmitter, the shaping process is via optimized coefficients in the linear combinations under prescribed performance constraints under dynamic environments, We shall refer to each of those channel transfer functions of a shaped beam as a composited transfer function (CTF).

Present invention features additional pre-processing at transmission side on available channel state information (CSI) that is formulated via channel transfer functions/matrices, through composited transfer functions (CTFs), or composited transfer matrices. The preprocessors are dynamically configured to “shape” the MIMO transfer functions so that the inputs of the preprocessors become accessible to user-selectable transfer functions via beam shaping and optimization algorithms similar to those used in many smart beamforming techniques. However, the discriminations in the composited transfer functions (CTFs) are expressed as directions specified as those parameters for in conventional shaped beams. These discrimination parameters are characterized as “user-index” specified. They effectively enable frequency re-use via “directional diversity”.

Optimally shaped or optimal composited transfer functions (CTFs) are for enhanced isolations among multiple users and will exhibit distinct features to various users. For a two-user MIMO example in a multipath dominated environment: a first set of parallel preprocessors for transmission in a hub may feature will create a first set of composited transfer functions (CTFs), characterizing propagation paths from the inputs of the pre-processors via (1) multiple transmitting elements over a selected frequency slot and (2) multipath dominant propagation channels all the way to various elements of the two user antennas. An optimized CTF features “high” intensity responses (beam peaks of a shaped beam) to antenna elements of a first user while concurrently shows “low” intensity responses (nulls or quiet zones) to all antenna elements of a second user. Concurrently, a second set of preprocessors are configured to generate a second set of CTFs with “low” intensity responses to all antenna elements of the first users while concurrently showing “high” intensity responses to antenna elements of the second user. As a result, the same transmitter can reuse the frequency spectrum to communicate independently to the two users via the two sets of CTFs operated over the same selected frequency slot.

Channel capacity for the transmitter to a user will benefit from a corresponding set of many available CTFs via convention MIMO principles. Outputs of two conventional MIMO transmitting processors, one for the first user and the other for the second user, are respectively connected to the inputs of the two sets of the preprocessors. The multiple outputs of the pre-processors are then connected to the same suite of the transmitting antenna elements. As a result, spectrum can be reused multiple times for better spectrum utility efficiency.

Our receiver approaches include techniques incorporating multiple antenna elements and using space-time-frequency adaptive processing. Coordinated multi-user communication networks coordinate and/or combine signals from multiple antenna elements or base stations to make it possible for mobile users to enjoy consistent performance and quality when they access and share videos, photos and other high-bandwidth services, whether they are close to the center of their serving cell or at its outer edges. One issue with these networks is that conventional channel quality feedback schemes do not take into account a reduction in interference that can be achieved by coordination. Thus, there are general needs for these networks and methods for beamforming coordination that take into account the reduction in interference that results from the coordination of the base stations. There are also general needs for channel quality feedback schemes suitable for interference suppression in a coordinated multi-user network.

### BRIEF DESCRIPTION OF THE DRAWINGS

FIG. 1 illustrates a communication network in a multipath dominated propagation environment (a) with antenna diversity and (b) with a multiple-input and multiple-output (MIMO) configuration in accordance with some embodiments.

FIG. 2 illustrates a MIMO scheme in accordance with some embodiments: (a) forming multiple independent links (on same frequency channel) between transmitter and receiver to communicate at higher total data rates, and (b) forming multiple independent links (on same frequency channel) between transmitter and receiver to communicate at higher total data rates, but there are cross-paths between antenna elements.

FIG. 3a illustrates a conventional MIMO scheme in characterizing a multipath dominated propagation channel by measuring transfer functions hᵢₖⱼ from an i^{th} transmitting element in a transmitter to a j^{th} receiving element of a k^{th} user in accordance with some embodiments.

FIG. 3b substantiates the configuration depicted in FIG. 3a; illustrating examples in time domain of a probing signal Pb_{ib}(t), a spreading code Cᵢ(t), received probing signals (in I/Q) at 1^{st} element of the k^{th} user, and received probing signals (in I/Q) at 2^{nd} element of the n^{th} user in a conventional MIMO scheme characterizing a multipath dominated propagation channel.

FIG. 4 illustrates an advanced scheme for MIMO CTFs in characterizing a multipath dominated propagation channel by measuring various components of a composited transfer functions; characterizing propagation effects from an input port of a transmitting beam, Ba, in a transmitter to a j^{th} receiving element of a k^{th} user.

FIG. 4a substantiates the configuration depicted in FIG. 4; illustrating examples in time domain of a probing signal Pb_{ib}(t), a spreading code Cᵢ(t), received probing signals (in I/Q) at 1^{st} element of the k^{th} user, and received probing signals (in I/Q) at 2^{nd} element of the n^{th} user in the advanced MIMO scheme characterizing a multipath dominated propagation channel.

FIG. 5 depicts signal flow diagrams for (a) a MIMO transmitter and (b) a MIMO receiver in accordance with some embodiments.

FIG. 6 illustrates a communication network in a multipath dominated propagation environment performing preprocessing to form two groups of user sensitive transfer functions in accordance with some embodiments.

FIG. 7a depicts a flow diagram in generating optimized composited transfer functions via updated channel state information (CSI) and specified beam shaping criteria for a MIMO transmitter in accordance with some embodiments.

FIG. 7b depicts a more detailed flow diagram in generating composited transfer functions via updated channel state information (CSI) for a MIMO transmitter in accordance with some embodiments.

FIG. 8A illustrates a communication network in a multipath dominated propagation environment performing preprocessing to form two groups of user sensitive transfer functions assuming users featuring two receiving antenna elements each in accordance with some embodiments.

FIG. 8B illustrates a communication network in a multipath dominated propagation environment performing preprocessing to form two groups of user sensitive transfer functions assuming both users featuring two receiving antenna elements each in accordance with some embodiments. One user also features wavefront multiplexing/demultiplexing for dynamic resource allocations among RF power and RF bandwidth resources of the transmitting elements.

FIG. 9 illustrates a multi-user communication configuration in a multipath dominated propagation environment with preprocessing to form two groups of orthogonal beams in a common frequency slot dedicated for two independent users in accordance with some embodiments.

FIG. 9A illustrates a multi-user communication configuration via parallel reflective walls in a multipath dominated propagation environment with preprocessing to form two groups of orthogonal beams in a common frequency slot dedicated for two independent users in accordance with some embodiments.

FIG. 10 illustrates a multi-user communication configuration with digital beam forming (DBF) networks and Wavefront muxing/demuxing for both transmitter or/and receivers in a multipath dominated propagation environment with preprocessing to form two groups of orthogonal beams, or beams with quiet-zones, in a common frequency slot dedicated for two independent users in accordance with some embodiments.

FIG. 10a illustrates a configuration modified from that of FIG. 10 for multi-user communication with digital beam forming (DBF) networks and Wavefront muxing/demuxing for both transmitter or/and receivers in a multipath dominated propagation environment with preprocessing to form two groups of orthogonal beams, or beams with quiet-zones, in a common frequency slot for three independent users in accordance with some embodiments.

FIG. 11 illustrates an alternative multi-user communication configuration with digital beam forming (DBF) networks and Wavefront muxing/demuxing for both transmitter or/and receivers in a multipath dominated propagation environment with preprocessing to form two groups of orthogonal beams, or beams with quiet-zones, in a common frequency slot dedicated for two independent users in accordance with some embodiments.

FIG. 12 illustrates a multiuser communication configuration with multibeam antenna (MBA) elements and Wavefront muxing/demuxing for transmitter in a multipath dominated propagation environment with preprocessing to form two groups of orthogonal beams, or beams with quiet-zones, in a common frequency slot dedicated for two independent users in accordance with some embodiments.

FIG. 13 illustrates a multiuser communication configuration with combinations of direct radiating elements and multibeam antenna (MBA) elements and Wavefront muxing/demuxing for transmitter in a multipath dominated propagation environment with preprocessing to form two groups of orthogonal beams, or beams with quiet-zones, in a common frequency slot dedicated for two independent users in accordance with some embodiments.

FIG. 14 illustrates another multiuser communication configuration with combinations of direct radiating elements and multibeam antenna (MBA) elements and Wavefront muxing/demuxing for transmitter in a multipath dominated propagation environment with preprocessing to form two groups of orthogonal beams, or beams with quiet-zones, in a common frequency slot dedicated for two independent users in accordance with some embodiments.

FIG. 14a illustrates another configuration slightly modified from that in FIG. 14 for multiuser communication with combinations of direct radiating elements and multibeam antenna (MBA) elements and Wavefront muxing/demuxing for transmitter in a multipath dominated propagation environment with preprocessing to form two groups of orthogonal beams, or beams with quiet-zones, in a common frequency slot dedicated for two independent users in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

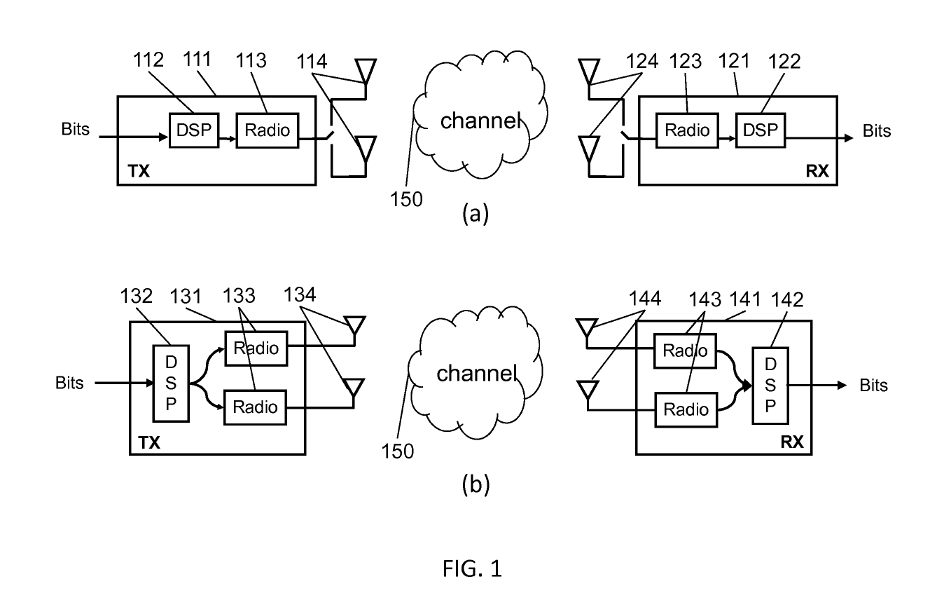

FIG. 1 illustrates a single user communication network in accordance with some embodiments. As depicted in panel (a) of FIG. 1, a communications system features a transmitter 111 with a transmit antenna with diversity 114, and a receiver 121 with a receive antenna with diversity 124. The transmitter 111 comprises a digital signal processor (DSP) 112 performing coding and other formatting functions on input signals, and a radio 113 comprising a frequency up-converter, and power amplifiers, or their equivalents. The receiver 121 comprises a radio 123 consisting of low noise amplifiers, frequency down-converters, digitizers, and a digital signal processor (DSP) 122 performing decoding and other re-formatting functions. In MIMO terminology, this is called Single Input, Single Output (SISO).

In information theory, the Shannon—Hartley theorem tells the maximum rate at which information can be transmitted over a communications channel 150 of a specified bandwidth in the presence of noise. The theorem establishes Shannon's channel capacity for such a communication link, a bound on the maximum amount of error-free information that can be transmitted with a specified bandwidth in the presence of the noise interference. According to Shannon, the capacity C of a radio channel 150 is dependent on bandwidth B and the signal-to-noise ratio S/N. The following applies to a SISO system:

C=B log₂(1+S/N) (1)

Conventional “Single Input Single Output” (SISO) systems were favored for simplicity and low-cost but have some shortcomings: (a) outage occurs if antennas fall into null; however, switching between different antennas 114 and 124 can help in circumventing channel fading; (b) radiated power is wasted by sending signals in all directions from omni directional transmitting antennas and will cause additional interference to other users; (c) sensitive to interference from all directions, and (d) total radiated power limited by output of a single power amplifier.

Panel (b) of FIG. 1 depicts a Multiple Input Multiple Output (MIMO) system with multiple parallel radios for single user. It features a transmitter 131 with a two transmit antennas 134, and a receiver 141 with two receive antennas 144. The transmitter 131 comprises a digital signal processor (DSP) 132 performing segmenting (or dividing), coding and other formatting functions on input signals, and a radio 133 consisting of modulators, a frequency up-converter, and power amplifiers, or their equivalents. The receiver 141 comprises a radio 143 consisting of low noise amplifiers, frequency down-converters, and demodulators, and a digital signal processor (DSP) 142 performing decoding, de-segmenting (or combining), and other re-formatting functions.

MIMO systems with multiple parallel radios in general improve the following, (a) outages due to dynamic fading are reduced by using information from multiple antennas, (b) total transmit power are increased via multiple power amplifiers, (c) higher throughputs are possible, and (d) transmit and receive interference can be limited by many techniques.

The MIMO system in panel (b) of FIG. 1 consists of n (n=2) transmitting and m (m=2) receiving antennas. By using the same channel 150 as that in panel (a) of FIG. 1, every receiving antenna 144 receives not only the direct components intended for it, but also the indirect components intended for the other antennas. The direct connection from a transmitting antenna 1 to a receiving element 1 is specified with h₁₁, etc., while the indirect connection from a transmitting antenna 1 to a receiving element 2 is identified as cross component h₂₁, etc. From this the transmission matrix is obtained with the dimensions (n×m=2×2) for the configuration on panel (b) of FIG. 1:

$$[ \begin{matrix}h 11 & h 21 \\ h 12 & h 22\end{matrix} ] \qquad ( 2 )$$

The following transmission formula results from receive vector y, transmit vector x, and noise n:

y=Hx+n. (3)

Data to be transmitted is divided into independent data sub-streams. The number of sub-streams M is always less than or equal to the number of transmitting antennas; in the case of asymmetrical (m×n) antenna constellations, it is always smaller or equal to the minimum number of antennas. For example, a 4×4 system could be used to transmit four or fewer streams, while a 3×2 system could transmit two or fewer streams. Theoretically, the capacity C increases linearly with the number of streams M

C=MB log₂(1+S/N) (4)

When the individual streams are assigned to various users, this is called Multi-User MIMO (MU-MIMO). This mode is particularly useful in the uplink because the complexity on the UE side can be kept at a minimum by using only one transmit antenna. This is also called ‘collaborative MIMO’. Cyclic delay diversity (CDD) introduces virtual echoes into OFDM-based systems. This increases the frequency selectivity at the receiver. In the case of CDD, the signals are transmitted by the individual antennas with a time delay. Because CDD introduces additional diversity components, it is particularly useful as an addition to spatial multiplexing.

Spatial diversity comprises receiving (Rx) and transmitting (Tx) versions. The purpose of spatial diversity in FIG. 1 is to make the transmission more robust. There is no increase in the data rate. This mode features redundant data on different paths.

Rx diversity uses more antennas on the receiver side than on the transmitter side. A simple scenario consists of two Rx and one Tx antenna (SIMO, 1×2). Because special coding methods are not needed, this scenario is very easy to implement. Only two RF paths are needed for the receiver. Because of the different transmission paths, the receiver sees two differently faded signals. By using the appropriate method in the receiver, the signal-to-noise ratio can now be increased. Switched diversity always uses the stronger signal, while maximum ratio combining uses the sum from the two signals.

On the other hand for Tx diversity, there are more Tx antenna elements than those of Rx antennas. A simple scenario uses two Tx and one Rx antenna elements (MISO, 2×1). The same data is transmitted redundantly over two antennas. This method has the advantage that the multiple antennas and redundancy coding is moved from the mobile UE to the base station, where these technologies are simpler and cheaper to implement.

To generate a redundant signal, space-time codes are used. Mr. Siavash Alamouti in his landmark October 1998 paper on IEEE Journal on Selected Areas in Communications Vol: 16, Issues: 8, “A Simple Transmit Diversity Technique for Wireless Communication,” offers a simple method for achieving spatial diversity with two transmit antennas. Space-time codes additionally improve the performance and make spatial diversity usable. The signal copy is transmitted not only from a different antenna but also at a different time. This delayed transmission is called delayed diversity. Alamouti's space-time codes combine spatial and temporal signal copies as followed:

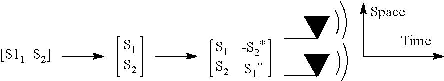

The signals S₁ and S₂ are multiplexed in two data chains. After that, a signal replication is added to create the Alamouti space-time block code.

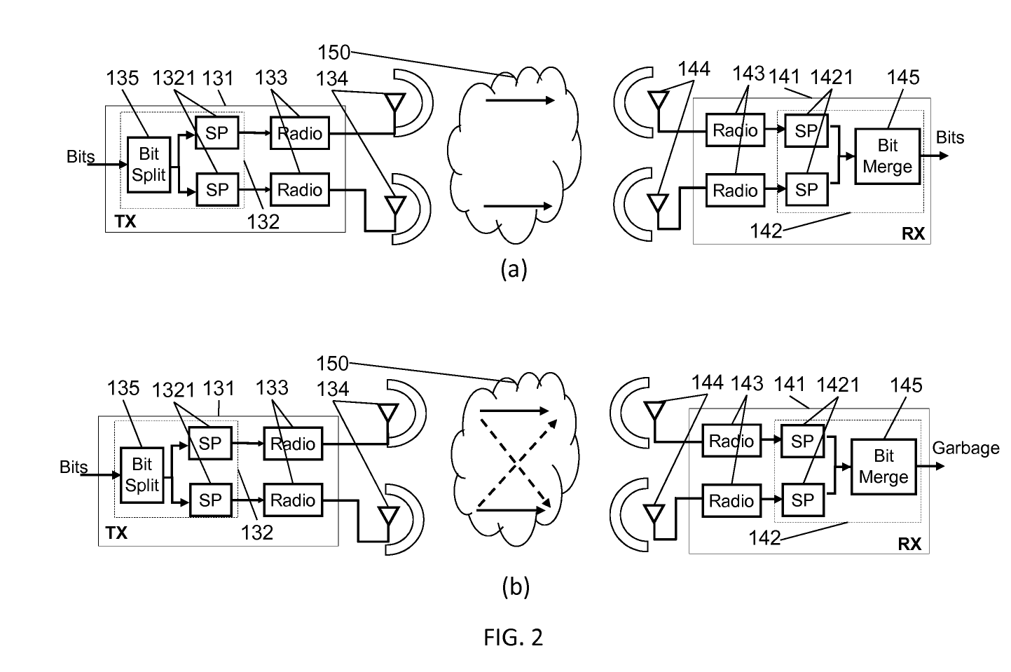

Spatial multiplexing in MIMO as depicted in FIG. 2 is not intended to make the transmission more robust; rather it increases the data rate. As depicted in panel (a) of FIG. 2, the DSP 132 comprises two portions, a segmenting device 135 and two signal processors (SP) 1321. An input data stream, a post-modulated signal stream, is divided or segmented by a segmenting device, or a splitter, 135 into 2 separate streams, which are to be transmitted independently via 2 separate antennas 134 after additionally coded (if any), and formatted by the SP 1321, frequency up-converted, and then power amplified by the radios 133. Each of the two SP 1321 shall perform spatial mapping to independently maximize multipath propagation effects from a corresponding transmitting element to a receiver 141

At a receiver 141, the two antennas 144 will capture the two separated data streams independently. In a simplified and idealized scenario, a first of the two antennas 144 will only respond to a first data stream sent by a first of the two transmitting antennas 134; while a second of the two antennas 144 will only respond to a second data stream sent by a second of the two transmitting antennas 134. The received streams then are properly conditioned by the radios 143 before reformatting, de-coded (if any) by the signal processors (SP) 1421 and then de-segmented by a combining device 145. The radios 143 perform, among other functions, low noise amplification, and frequency down conversion. The functions of SP 1421 and combiner 145 are parts of functions of the DSPs 142. In some implementations, one of the two SP 1421 may perform part of multipath equalization complimenting the preprocessing by one of the SPs 1321 in the transmitter. A pair of such two SPs, one in a transmitting chain 1321 of a transmitting element and the other in a receiving chain 1421 of a receiving element is a key processing of MIMO maximizing multipath effects of a propagation channel 150 while isolating leakages from adjacent pairs of transmitting/receiving elements

However, there are cross-paths between antennas in real world as shown in panel (b) of FIG. 2. When the SP 1321 and 1421 are not properly configured to take advantage of the multipath effects of the propagation channel 150, transmissions using cross components not equal to 0 will mutually influence one another. The first of the two receiving antennas 144 will also respond to the second data stream sent by the second antenna of the transmitting antennas 134. Similarly, the second of the two receiving antennas 144 will also respond to the first data stream sent by the first of the two transmitting antennas 134. When strong effects of cross-paths occur, the received signals by the two received antennas 144 shall exhibit high cross-correlation. On the other hand, when effects of cross-paths become weak, so will the cross correlations among the two received signal or data streams. The cross correlations must be minimized by signal processors 1421 via optimization algorithms. Correlations between the two received substreams must be decoupled before a de-segmenting, summing, or merging device 145. As indicated, before the two substreams are optimally processed by the two SPs 1421, the output of the de-segmenting device 145 will be data streams with high self-interference.

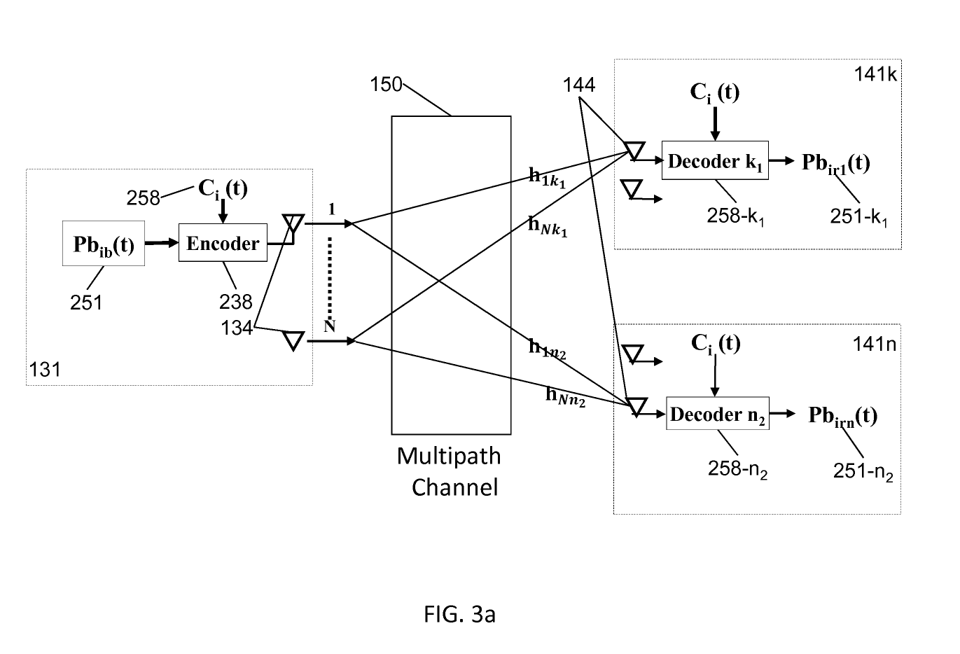

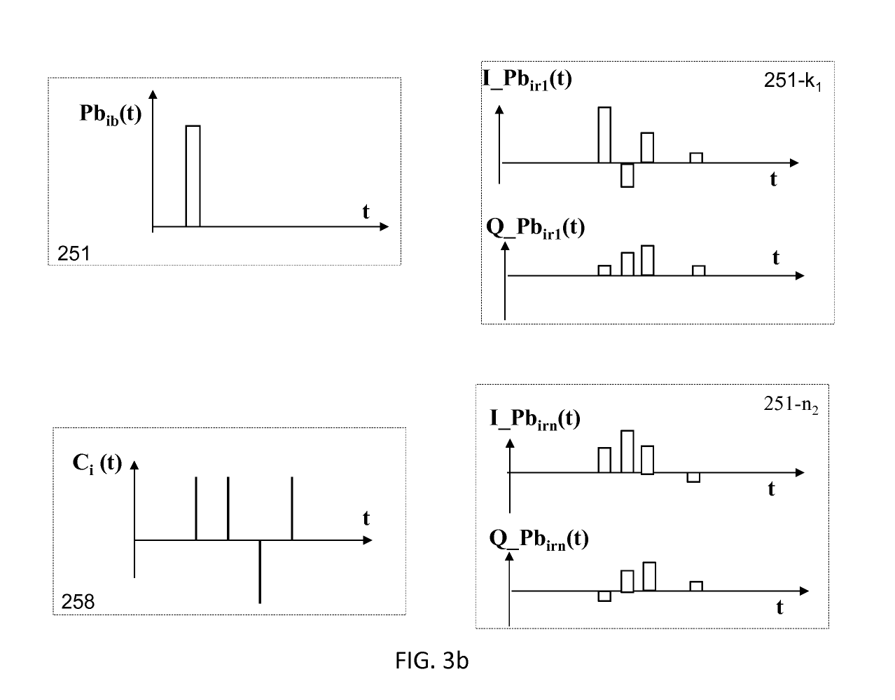

FIG. 3A illustrates a conventional MIMO scheme in characterizing a multipath dominated propagation channel by measuring transfer functions from an ith transmitting element in a transmitter to a j^{th} receiving element of a k^{th} user in accordance with some embodiments. A probing signal 251, Pb(t), is encoded by an encoder 238 by a spreading code 258, before sent to various user elements by one of various transmitting elements 134. Different transmitting elements may be associated with various probing signals. One such an example of Pb(t) is illustrated in FIG. 3b. The encoded probing signals, after propagating through a multipath dominated propagation channel 150, arrive at various receiving elements k₁ through n₂. The received probing signals after properly conditioned (low-noised amplified, filtered, frequency down converted, and digitized) will be sent to various decoders, 258-k₁ to 258-n2, which perform de-spreading process. The received probing signals 251-k₁ and 251-n₂ as depicted in FIG. 3b, will be used to dynamically update the transfer functions; h₁ₖ₁, h_{Nk1} h₁ₙ₁, and h_{Nn2} which feature multipath propagation effects in both I and Q channels representing time delays, phase and amplitude effects from various transmitting elements to many receiving elements of different users.

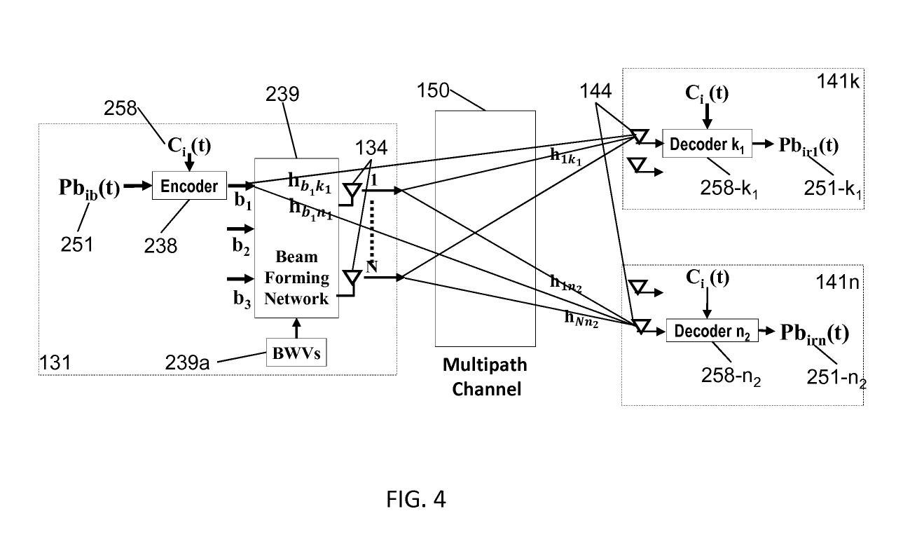

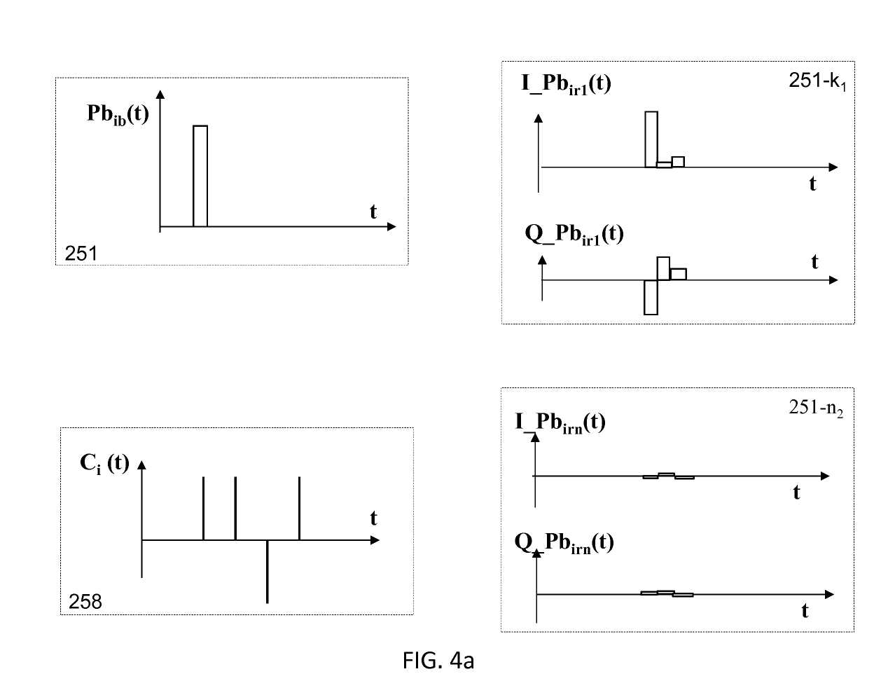

FIG. 4 illustrates a beam forming scheme for MIMO in characterizing a multipath dominated propagation channel by measuring transfer functions from a beam input of a transmitting beam, Ba, in a transmitter to a j^{th} receiving element of a k^{th} user. A composited transfer function (CTF), featuring point-to-multipoint (p-to-mp) characteristics, is generated by a linear combination of various conventional transfer functions from different transmitting elements to a set of same receiving elements. This function, a CTF, will enable us to impose multiple concurrent and discriminative performance constraints onto combined effects of (controllable) transmitted RF waves and those in a not controllable but measurable propagation channel.

For frequency reuse among multiple users in MIMO, it would be ideal to have signal stream A, after going through a controllable processor or a device with one input and N-outputs, and radiated by N elements in a transmitter, the corresponding RF radiations will go through multipath dominant channel and reach various destinations. The m outputs of the device have be weighted individually by various amplitude and phase weighting parameters, the weighted outputs are connected to the m elements individually.

As an example, the following scenario may happen; (1) a relatively strong RF strength, say 10 dBm/m², associated with the steam A appears in a first destination (for a first user), while (2) extremely weak RF strengths, say <−40 dBm/m², associated with the steam A appear in a second destination (for a second user), and (3) relatively weak RF strengths, say <−20 dBm/m², associated with the stream A appear in a region covering a third, a fourth and a fifth destinations (for a 3^{rd}, a 4^{th}, and a 5^{th} users).

This controllable device generates a CTF which features RF performances favoring one user while discriminating against all other users under the three concurrent and discriminative constraints as illustrated in the above example.

The device that performs a linear combination over a transmitting array with N antenna elements is a 1-to-N beam-forming network (BFN). The associated weighting parameters to various transfer functions are a weighting vector, referred as beam-weighting vector, or BWV. By changing the BWV, the associated radiating pattern (the wavefront) of an updated beam by the BFN will be altered accordingly. With N-elements, the radiating pattern from an array can be optimized or shaped to meet precisely up-to N independent performance constraints including: forming beam peaks and nulls at those constraining directions, or a location of receiving element which picks up and integrates groups of multi-path scattered signals from the communications channel radiated by the transmitting beam. On the other hand, optimized radiation patterns with N components of a BWV may be shaped to meet more than N constraints. The performance constraints that integrate both effects of shaped radiation patterns and dynamic multipath effects in a communication channel may also be specified with preferred coverage zones and rejection zones or quiet zones. Over a specified quiet zone, the intensity levels of radiated signals by the shaped beam after scattered by a multipath dominated channel are below a pre-determined threshold with low intensity levels, usually a −35 to −50 dB below the levels of coverage zones.

A probing signal 251, Pb(t), is encoded by an encoder 238 with a spreading code 258, before sent to an input of a beam forming network (BFN) 239 with multiple transmitting elements 134. A beam weight vector 239a (BWV) is optimized under a set of performance constraints (not shown). The probing signals are then radiated to a multipath dominated propagation channel 150. One such an example of probing signal Pb(t) 251 and that of a spreading code Cᵢ(t) 258 are depicted in FIG. 4a. As a result, the received probing signals captured by various user elements 144 will feature “directional dependent” characteristics. The encoded signals, after propagating through a multipath dominated channel 150, arrive at various receiving elements, k₁ through n₂, are captured by these elements 144 individually. The received probing signals after properly conditioned (low-noised amplified, filtered, frequency down converted, and digitized) will be sent to various decoders, 258-k₁ to 258-n₂, which perform de-spreading process. The received probing signals 251-k₁ to 251-n₂ feature multipath propagation effects in both I and Q channels representing time delays, phase and amplitude effects. For this example with beam port b1 as an input to a CTF, the desired coverage zone is set for the k^{th} receiver. Therefore, received optimized probing signals in I/Q format by the k₁ element depicted in the inserted details of 251-k₁ in FIG. 4a feature high intensities of multiple pulses. The received signals will be used to equalize the “propagation transfer function from the b1 beam port of a beam forming network 239 to the element k1 of the first receiver 141k, as indicated by hb₁ₖ₁. On the other hand, a rejection zone or a quiet zone is assigned to the n^{th} receiver. As a result, received optimized probing signals in I/Q format by the second receiving element of the n^{th} receiver after decoded by a decoder 258-n₂, characterized by hb₁ₙ₂, feature extremely low intensities of multiple pulses as depicted in the inserted 251-n₂ in FIG. 4a.

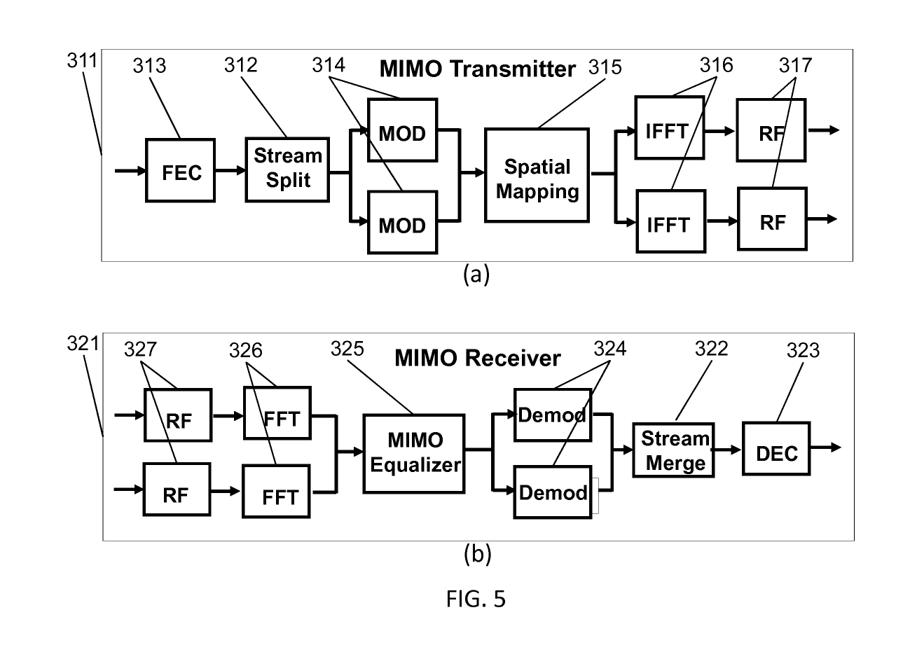

FIG. 5 depicts signal flow charts of typical MIMO systems for single users: (a) for MIMO transmitters 311 and (b) for MIMO receivers 321. There are feedback networks (not shown) for dynamic updating the channel state information (CSI). As depicted in panel (a) of FIG. 5, an input signal stream after channel-coded by a forward error correction (FEC) device 313 for a typical MIMO transmitter is segmented into multiple parallel substreams by a splitter 312. The substreams after modulated by a bank of modulators 314 will be spatially mapped into different combinations of modulated signals with transmitting antenna indices at each time instance via a spatial mapping device/block 315. To convert space-time streams (STS) into transmit chains (TC), a spatial mapping block may be implemented via, among many other techniques, (1) direct mapping, a 1-to-1 mapping from STS to TC; (2) spatial expansion, additional multiplication with a matrix for cases such as two STS and three Tx antennas; (3) beam forming, additional multiplication with a steering vector; and (4) subcarrier mapping. Multiple parallel outputs from the spatial mapping block 315 for a transmitting antenna are converted to a TC format by devices such as IFFT blocks 316 before frequency up-converted and power amplified by RF blocks 317. Various transmitting antennas (not shown) will then radiate different power-amplified signals concurrently.

In a typical MIMO receiver as depicted in panel (b) of FIG. 5, multiple receive signals captured by various Rx antennas are conditioned properly individually by RF frontends 327 which may comprise low-noise-amplifiers and frequency down-converters. At baseband digital format, FFT processors 326 channelize the received substreams; and the channelized signals are equalized and spatially unmapped into STS signals by a MIMO equalizer 325. After demodulated by demodulators 324 and merged into single streams by de-segmenting devices 322, the recovered STS signals are decoded by a decoder 323 and become reconstituted original data.

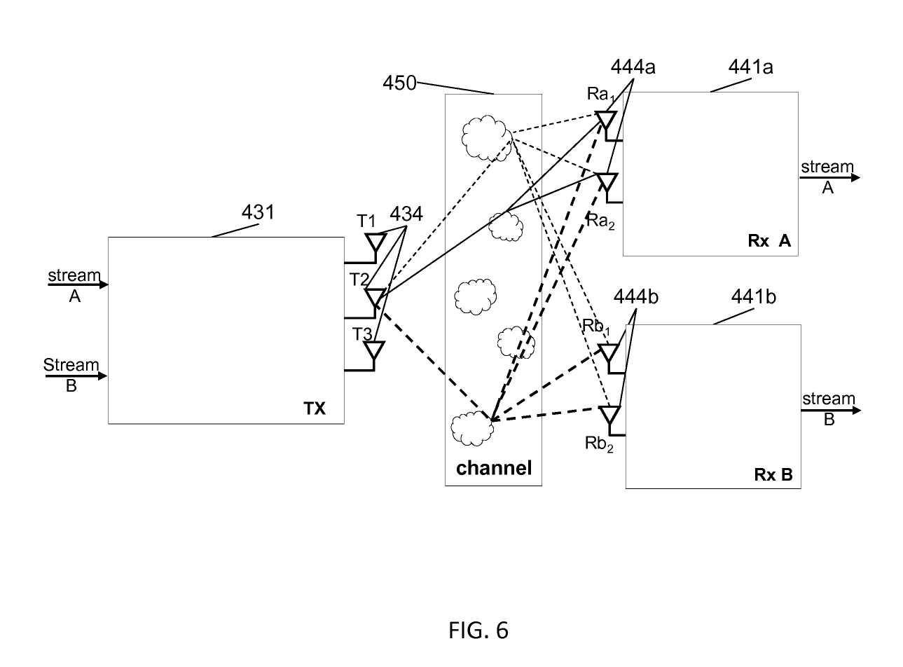

FIG. 6 depicts a point-to-2 point (p-to-2p) communications system featuring a transmitter 431 at a source with 3 Tx elements 434, T1, T2, and T3, sending 2 signal streams independently through a multipath dominated communication channel 450 to two different receivers Rx A at a first destination and Rx B at a second destination. The two streams, streams A and B, are concurrently radiated by the three common radiators or transmitting antenna elements 434; and after propagating through a multi-path dominated RF channels will arrive at two separated user sites; Rx A 441a and Rx B 441b independently with a minimum mutual interference.

The first receiver Rx A 441a features two Rx elements Ra₁ and Ra₂ 444a to capture a first part of radiated signals by the transmitter 431 dedicated for the first receiver Rx A. Concurrently, the second receiver Rx B 441b featuring two Rx elements Rb1 and Rb2 444b will capture a second part of radiated signals by the transmitter 431 dedicated for the second receiver Rx B. The designed configurations will deliver signals to two destinations, each destination with two receiving elements concurrently. Data stream A will be only delivered to and captured by antenna elements in Rx A 441a, while data stream B only to antenna elements of Rx B 441b. There are also feedback networks (not shown) for dynamic updating the channel state information (CSI). CSI can be organized as transfer functions; hᵢₖ characterizing propagation features of a set of multiple propagation paths from i^{th} element of a transmitter to a k^{th} element of a receiver. For a communications systems with M antenna element in transmitting and N elements in receiving the transfer functions can be represented by a M×N transfer matrix.

It is noticed that the transfer functions/matrices characterizing propagation channels feature parameters indexed by user's antenna elements, neither in forms of locations as lengths in a Cartesian coordinates nor in direction as angles in a spherical coordinates. More precisely, they are specified or indexed by antenna element IDs of various users. We shall refer these identification conventions as “user ID indexed” or simply as “user indexed’ in this application. Therefore, the phrase of “user indexed performance criteria” means performance criteria at locations identified by ID of user element. A user indexed transfer function hᵢₖ represents a transfer function between the i^{th} element of a transmitting array to a receiver element indexed the by k^{th} element of a receiver.

Many conventional antenna synthesis designs and methods feature optimizations in beam shaping techniques for a transmitting array with multiple transmitting antenna elements in formulating a shaped beam radiation pattern as a weighted sum of radiation patterns of individual antenna elements. Furthermore, the optimization process is to find a set of the weighting parameters of the individual element radiation patterns for the weighted sum so that the performances of the optimized shaped beam fulfill a set of pre-determined performance constraints. Both the radiation patterns of shaped beams and associated performance constraints are specified as functions of angles in various coordinates. The shaped beam will radiate a set of information into various directions in space according to its radiation pattern. However, measurements of known probing signals injected to the shaped beam on discrete locations, or spatially sampled points, in a common coverage region for receivers, such as receiving elements of multiple receivers, may be used for optimizing the shaped beam so that the received signals at those discrete locations meet prescribed performance criteria, which are specified as functions of user indexes, not directions or angles on the radiation patterns of the shaped beam. The performance constraints on these selected locations are characterized as a point-to-multipoint (p-to-mp) composited transfer function from the input of a shaped beam in a transmitter to multiple element locations of various set of user equipment (UE), which includes (1) integrated effects of radiation pattern of the shaped beam, and (2) multipath effects in a dynamic propagation channel.

In this patent application, many of the transfer functions have been indexed by subscripts with two or three symbols.
i. hᵢⱼ: to characterize propagation features of channel characteristics from an ith element of a transmitter via a set of multiple propagation paths to a j^{th} element of a receiver.
ii. h_{ibj}: to characterize propagation features of channel characteristics from an ith element of a transmitter via a set of multiple propagation paths to a j^{th} element of receiver-b.
iii. hbᵢⱼ: to characterize propagation features of channel characteristics from an ith beam port of a transmitter via a set of multiple propagation paths to a j^{th} element of a receiver; and
iv. hbᵢₐⱼ: to characterize propagation features of channel characteristics from an ith beam port of a transmitter via a set of multiple propagation paths to a j^{th} element of receiver-A (Rx A).

In some embodiments, we will incorporate concepts of orthogonal beams (OB) at the transmit side: forming two groups of shaped beams, which are injected to a multipath dominated propagation channel. Instead of using line-of-sight directions as constraint parameters in beam shaping optimization, we use components of a scattering matrix, known as transfer functions, characterizing time delays, amplitude attenuations, and phase delays from the i^{th} element position in a transmitter via a set of multipaths of the propagation channel to the j^{th} position in a k^{th} receiver. They are indexed by user element identifications (IDs). The first sets of shape beams will feature beam peaks toward first receiver and nulls toward the second receiver, while the second sets of shape beams with beam peaks toward the second receiver and nulls toward the first receiver. These two sets are “orthogonal” to one another. A shaped beam is constrained by a composited transfer function, which is a linear combinations of all transfer functions, hᵢₖ for all the i; where i is the index of the i^{th} transmitting elements. A composited transfer function features discrete components characterizing effects of propagation, respectively, from the input of a shape beam in a transmitter to various elements on receivers from multiple sets of user equipment through a multipath dominated communications/propagation channel. A composited transfer function is constrained by a set of functions on multiple locations indexed by IDs of user elements instead of directions.

In other embodiments, we will incorporate concepts of “quiet zones” at the transmit side forming two groups of beams. These two sets of shaped beams will be formed at the transmission side taking advantage of the multipath dominated features of a communications/propagation channel. Instead using of line-of-sight directions as constraint parameters in beam shaping optimization, we will use components of a scattering matrix, known as transfer functions hᵢⱼ, characterizing time delays, amplitude attenuations, and phase delays in propagation via a set of multipaths from the i^{th} position in a transmitter to the j^{th} position in a receiver. The first sets will have shape beams with beam peaks toward first receiver and “quiet zones” toward the second receiver, while the second sets will have shape beams with beam peaks toward the second receiver and “quiet-zone” toward the first receiver.

“Quiet zone” criteria are different from “nulling.” Over “selected” quiet zones the associated transfer functions will be below a predefined threshold value on received desired probing signal strengths; which shall be −20 or −30 dB below those at the beam peaks of the shaped beams. Beam shaping constraints via quiet zones are set for low intensity responses on composited transfer functions over a region, while those for OB are set for zero responses over specified locations only.

As an example to FIG. 4, the first input stream, stream A, to be transmitted to Rx A 441a may be divided into two substreams: signal substream A1 for Ra1 and signal substream A2 for Ra2. A1 substream will be connected to a first input of a first 2-to-3 beam-forming-network (BFN) (not shown but similar to the one shown in FIG. 4) for a first shaped beam. Similarly, A2 substream is connected to a second input of the first 2-to-3 beam-forming-network (BFN) for a second shaped beam. The three combined outputs for the two shaped beams from the first 2-to-3 BFN are frequency up-converted, amplified by 3 power amplifiers, and then radiated by three transmitting elements 434. Signal substreams of A1 and A2 radiated by three transmitting elements 434 organized via two transmitting shaped beams shall feature two independent radiation patterns, or wavefronts. After scattered in a multipath dominated channel 450, these radiation patterns or wavefronts shall deliver transmitted signals with discriminative features; low intensities of flux densities of radiated A1 and A2 signal substreams for the second receiver Rx B 441b at the second destination, and high intensities of radiated A1 and A2 signal substream flux densities for the first receiver 441a over the first destination. Furthermore, the first shaped beam shall aim for maximizing the signal flux density of A1 substream over the first element Ra1 of the receiving elements 444a, while the second shaped beam shall aim for maximizing the signal flux density of A2 substream over the second element Ra2 of the receiving elements 444a.

Similarly, stream B to be transmitted to Rx B 441b may also be divided into two substreams: signal substream B1 for Rb1 and signal substream B2 for Rb2. B1 substream will be connected to a first input of a second 2-to-3 beam-forming-network (BFN) (not shown but similar to the one shown in FIG. 4) for a third shaped beam. Similarly, B2 substream is connected to a second input of the second 2-to-3 beam-forming-network (BFN) for a fourth shaped beam. Signal substreams of B1 and B2 radiated by the same three transmitting elements 434 organized via two transmitting shaped beams shall feature two independent radiation patterns, or wavefronts. After scattered in a multipath dominated channel 450, these radiation patterns or wavefronts shall deliver transmitted signals with discriminative features; low intensities of flux densities of radiated B1 and B2 signal substreams at the receiving elements 444a of the first receiver Rx A 441A, and high intensities of radiated B1 and B2 signal substream flux densities for receiving elements 444b of the second receiver 441b.

In many embodiments for FIG. 6, we may define hᵢₐₓ as the scattering matrix component from a Tᵢ element of a transmitter to the x^{th} element of receiver A (Rx A) where i=1, 2, or 3 and x=1, or 2. Similarly, h_{ibx} as the scattering matrix component from the Tᵢ element to the x^{th} element of the receiver B, Rx B; where i=1, 2, or 3 and x=1, or 2. A first beam forming mechanism for a beam Bₐ₁ is resided in a first 2-to-3 BFN. The signal substream A1, to be radiated by the beam Bₐ₁, is connected to a first beam port, BPₐ₁, of the first 2-to-3 BFN.

Referring back to FIG. 4 with the number of transmitting element N=3, a composited transfer function, H_Bₐ₁, from the beam port BPₐ₁ (a source point, say b1 of a BFN 239) to a set of receiving elements 144,

$$[ \begin{matrix}Ra 1 \\ Rb 1 \\ Rb 2\end{matrix} ]$$

(multiple destination points), is defined as a linear combination of [T₁₁], [T₂₁] and [T₃₁]; where [T_{iy}] is a scattering matrix, a set of transfer functions, from the i^{th} transmitting element to the set of receiving elements

$$[ \begin{matrix}Ray \\ Rb 1 \\ Rb 2\end{matrix} ]$$

where y=1 or 2. More specifically, the composited transfer function is expressed as:

$$\begin{matrix}\begin{matrix}{H\_B}_{a 1} = {wa}_{1} * [ {T}_{11} ] + {wa}_{2} * [ {T}_{21} ] + {wa}_{3} * [ {T}_{31} ] \\ = {wa}_{1} [ \begin{matrix}{h}_{1 {a}_{1}} \\ {h}_{1 {b}_{1}} \\ {h}_{1 {b}_{2}}\end{matrix} ] + {wa}_{2} [ \begin{matrix}{h}_{2 {a}_{1}} \\ {h}_{2 {b}_{1}} \\ {h}_{2 {b}_{2}}\end{matrix} ] + {wa}_{3} [ \begin{matrix}{h}_{3 {a}_{1}} \\ {h}_{3 {b}_{1}} \\ {h}_{3 {b}_{2}}\end{matrix} ] \\ = [ \begin{matrix}{wa}_{1} * {h}_{1 {a}_{1}} + {wa}_{2} * {h}_{2 {a}_{1}} + {wa}_{3} * {h}_{3 {a}_{1}} \\ {wa}_{1} * {h}_{1 {b}_{1}} + {wa}_{2} * {h}_{2 {b}_{1}} + {wa}_{3} * {h}_{3 {b}_{1}} \\ {wa}_{1} * {h}_{1 {b}_{2}} + {wa}_{2} * {h}_{2 {b}_{2}} + {wa}_{3} * {h}_{3 {b}_{2}}\end{matrix} ] \\ = [ \begin{matrix}{h}_{ba 1 - a 1} \\ {h}_{ba 1 - b 1} \\ {h}_{ba 1 - b 2}\end{matrix} ]\end{matrix} & ( 5 ) \\ Where [ {T}_{11} ] = [ \begin{matrix}{h}_{1 {a}_{1}} \\ {h}_{1 {b}_{1}} \\ {h}_{1 {b}_{2}}\end{matrix} ] & ( 5 a ) \\ [ {T}_{21} ] = [ \begin{matrix}{h}_{2 {a}_{1}} \\ {h}_{2 {b}_{1}} \\ {h}_{2 {b}_{2}}\end{matrix} ] & ( 5 b ) \\ [ {T}_{31} ] = [ \begin{matrix}{h}_{3 {a}_{1}} \\ {h}_{3 {b}_{1}} \\ {h}_{3 {b}_{2}}\end{matrix} ] & ( 5 c )\end{matrix}$$

We have defined the following components for the composited transfer function for beam Bₐ₁; (1) hbₐ₁₋ₐ₁ as a scattering function from the beam port BPₐ₁ to Ra1 element, (2) hb_{a1-b1} as a scattering function from the beam port BPₐ₁ to Rb1 element, and (3) hb_{a1-b2} as a scattering function from the beam port BPₐ₁ to Rb2 element.

For OB beam shaping, Beam Bₐ₁ shall feature “zero” responses or nulls at both Rb₁ and Rb₂, as specified in constraints 1 and 2:

i. hb_{a1-b1}=wa₁*h_{1b}_{₁}+wa₂*h_{2b}_{₁}+wa₃*h_{3b}_{₁}=0 (6a)

ii. hb_{a1-b2}=wa₁h*h_{1b}_{₂}+wa₂*h_{2b}_{₂}+wa₃*h_{3b}_{₂}=0 (6b)

Beam Bₐ₁ shall also feature a peak at Rₐ₁ location with constraint 3:

$$iii . {max}_{{wa}_{1} , {wa}_{2} , {wa}_{3}} ( \vert {hb}_{a 1 - a 1} \vert ) = {max}_{{wa}_{1} , {wa}_{2} , {wa}_{3}} ( \vert {wa}_{1} * {h}_{1 {a}_{1} a 1} + {wa}_{2} * {h}_{2 {a}_{1} a 1} + {wa}_{3} * {h}_{3 {a}_{1} a 1} \vert ) \\ where max ( x ) is an operation to maximize x . \qquad ( 6 c )$$

With three equations of 6a, 6b and 6c, an optimization algorithm shall lead us to an optimal set of solutions for wa₁, wa₂ and wa₃ as the optimized weighting components of a beam weighting vector (BWV) for Beam BBₐ₁ under the above three constraints of OB beams. Various optimization algorithms shall provide different solutions for the weighting component: wa₁, wa₂, and wa₃. Optimized solutions fulfilling the OB beam shaping must meet all 3 constraints (6a, 6b and 6c) concurrently.

For “quiet-zone” beam shaping, Beam Bₐ₁ shall feature a peak at Rₐ₁ location with constraint 3, and low response of the composited transfer functions at R_{b1} and Rb₂ with constraints 4 and 5:

$$iii . {max}_{{wa}_{1} , {wa}_{2} , {wa}_{3}} ( \vert {hb}_{a 1 - a 1} \vert ) = {max}_{{wa}_{1} , {wa}_{2} , {wa}_{3}} ( abs ( {wa}_{1} * {h}_{1 {a}_{1}} + {wa}_{2} * {h}_{2 {a}_{1}} + {wa}_{3} * {h}_{3 {a}_{1}} ) ) \qquad ( 6 c )$$

iv. abs(hb_{a1-b1})=|wa₁*h_{1b}_{₁}+wa₂*h_{2b}_{₁}+wa₃*h_{3b}_{₁}|<δ (6d)

v. abs(hb_{a1-b2})=|wa₁*h_{1b}_{₂}+wa₂*h_{2b}_{₂}+wa₃*h_{3b}_{₂}|<δ (6e)
where δ₁ is a small positive number, and shall be less than −20 dB of the maximized amplitude in constraint iii; e.g. δ₁ shall be <0.1 when the beam peak in constraint iii is normalized to unity.

With three equations of 6d, 6e and 6c, an optimization algorithm shall lead us to an optimal set of solutions for wa₁, wa₂ and wa₃ as the optimized weighting components of a beam weighting vector (BWV) for Beam Bₐ₁ under the constraints of “quiet zone”. However, there may be more constraint locations with low responses on the composited transfer functions over the receiving apertures of the second receiver in addition to Rb1 and Rb2. Adding more constraints will result in increased dimension of associated beam weight vectors (BWVs).

In other embodiments, there are 4 spatial-sampling points in the second destination; Rb1, Rb2, Rb3 and Rb4. The following two additional components for the composited transfer function for beam Bₐ₁ are defined; (1) h_{ba1-b3} as a measured scattering function from the beam port BPₐ₁ at the transmitting site to a third sensing device or receiving element, Rb3, (2) h_{ba1-b4} as a measured scattering function from the beam port BPₐ₁ to a fourth sensing/receiving element Rb4. As a result, the constraints 4 and 5 are re-set as

iv. abs(hb_{a1-b1})+abs(hb_{a1-b2})+abs(hb_{a1-b3})<δ1 (6d-1)

v. abs(hb_{a1-b1})+abs(hb_{a1-b4})<δ1 (6e-1)

Various optimization algorithms provide different solutions for the weighting component: wa₁, wa₂, and wa₃. The optimized solutions fulfilling the “quiet zone” beam shaping must meet all 3 constraints (6d, 6e and 6f).

Concurrently, a second beam forming mechanism for a beam Bb₁ in the second shaped beam set implemented by a second of the two BFNs. BBb₁ is an input to the beam forming network of the beam B_{b1}. The transfer function from B_{b1} to

$$[ \begin{matrix}{Rb}_{1} \\ {Ra}_{1} \\ {Ra}_{2}\end{matrix} ]$$

is defined as a linear combinations of [T₁₁′], [T₂₁′], and [T₃₁′]; where [T_{iy}′] is the scattering matrix, a set of transfer functions, from the i^{th} transmitting element to the second set of receiving elements

$$[ \begin{matrix}Rby \\ Ra 1 \\ Ra 2\end{matrix} ] .$$

$$\begin{matrix}\begin{matrix}{H\_B}_{b 1} = {wb}_{1} * [ {T}_{11}^{′} ] + {wb}_{2} * [ {T}_{21}^{′} ] + {wb}_{3} * [ {T}_{31}^{′} ] \\ = {wb}_{1} [ \begin{matrix}{h}_{1 {b}_{1}} \\ {h}_{1 {a}_{1}} \\ {h}_{1 {a}_{2}}\end{matrix} ] + {wb}_{2} [ \begin{matrix}{h}_{2 {b}_{1}} \\ {h}_{2 {a}_{1}} \\ {h}_{2 {a}_{2}}\end{matrix} ] + {wb}_{3} [ \begin{matrix}{h}_{3 {b}_{1}} \\ {h}_{3 {a}_{1}} \\ {h}_{3 {a}_{2}}\end{matrix} ] \\ = [ \begin{matrix}{wb}_{1} * {h}_{1 {b}_{1}} + {wb}_{2} * {h}_{2 {b}_{1}} + {wb}_{3} * {h}_{3 {b}_{1}} \\ {wb}_{1} * {h}_{1 {a}_{1}} + {wb}_{2} * {h}_{2 {a}_{1}} + {wb}_{3} * {h}_{3 {a}_{1}} \\ {wb}_{1} * {h}_{1 {a}_{2}} + {wb}_{2} * {h}_{2 {a}_{2}} + {wb}_{3} * {h}_{3 {a}_{2}}\end{matrix} ] \\ = [ \begin{matrix}{hb}_{b 1 - b 1} \\ {hb}_{b 1 - a 1} \\ {hb}_{b 1 - a 2}\end{matrix} ]\end{matrix} & ( 7 ) \\ Where [ {T}_{11}^{′} ] = [ \begin{matrix}{h}_{1 {b}_{1}} \\ {h}_{1 {a}_{1}} \\ {h}_{1 {a}_{2}}\end{matrix} ] & ( 7 a ) \\ [ {T}_{21}^{′} ] = [ \begin{matrix}{h}_{2 {b}_{1}} \\ {h}_{2 {a}_{1}} \\ {h}_{2 {a}_{2}}\end{matrix} ] & ( 7 b ) \\ [ {T}_{31}^{′} ] = [ \begin{matrix}{h}_{3 {b}_{1}} \\ {h}_{3 {a}_{1}} \\ {h}_{3 {a}_{2}}\end{matrix} ] & ( 7 c )\end{matrix}$$

With OB beam shaping, Beam B_{b1} shall feature nulls at Ra₁ and Ra₂ with constraints 6 and 7, and a peak at Rb1 location with constraint 8;

vi. abs(hb_{b1-a1})=wb₁*h₁ₐ_{₁}+wb₂*h₂ₐ_{₁}+wb₃*h₃ₐ_{₁}=0 (8a)

vii. abs(hb_{b1-a2})=wb₁h*h₁ₐ_{₂}+wb₂*h₂ₐ_{₂}+wb₃*h₃ₐ_{₂}=0 (8b)

$$viii . {max}_{{wb}_{1} , {wb}_{2} , {wb}_{3}} ( \vert {hb}_{b 1 - b 1} \vert ) = {max}_{{wb}_{1} , {wb}_{2} , {wb}_{3}} ( \vert {wb}_{1} * {h}_{1 {b}_{1} b 1} + {wb}_{2} * {h}_{2 {b}_{1} b 1} + {wb}_{3} * {h}_{3 {b}_{1} b 1} \vert ) \qquad ( 8 c )$$

Various optimization algorithms shall provide different solutions for the weighting component: wb₁, wb₂, and wb₃. Solutions fulfilling the OB beam shaping for the second sets of shaped beams must meet all 3 constraints (8a, 8b, and 8c) concurrently.

For “quiet-zone” beam shaping, Beam B_{b1} shall feature low amplitude response on composited transfer functions at Ra₁ and Ra₂ with constraints 9 and 10

ix. |hb_{bb1-a1}|=|wb₁*h₁ₐ_{₁}+wb₂*h₂ₐ_{₁}+wb₃*h₃ₐ_{₁}|<δ₁ (8d)

x. |hb_{bb1-a2}|=|wb₁*h₁ₐ_{₂}+wb₂*h₂ₐ_{₂}+wb₃*h₃ₐ_{₂}|<δ₁ (8e)

Beam B_{b1} features a peak at R_{b1} location with constraint 11

$$xi . {max}_{{wb}_{1} , {wb}_{2} , {wb}_{3}} ( \vert {h}_{bb 1 - b 1} \vert ) \qquad ( 8 f )$$

As a result of pre-processing with either OB or quiet zone criteria, the two antennas 444a at the first receiving sites Rx A 441a will only capture radiated signal stream “A” while the two antennas 444b at the second receiving site Rx B 441b will only be accessible to radiated stream “B” signals.

The received signals at Rx A are represented as A1′ by the first element Ra1, and A2′ by the second element Ra2, respectively. A1′ comprises a first linear combination of received A1 substream and received A2 substream, while A2′ comprises a second linear combination of received A2 substream and received A1 substream. A1′ and A2′ are conditioned accordingly by two receiving radios independently, and then post-processed to recover received data/signal stream “A”. Concurrently, the received signals at Rx B are represented as B1′ by the first element Rb1, and B2′ by the second element Rb2, respectively. B1′ comprises of a first linear combination of received B1 substream and received B2 substream, while B2′ comprises of a second linear combination of received B2 substream and received B1 substream. B1′ and B2′ are conditioned accordingly by two receiving radios independently, and then post-processed to recover received data/signal stream “B”.

Thus the radiated signal streams “A” and “B” at a common RF frequency slot are fully reconstituted at Rx A and Rx B sites independently. The “conditioning” performed by the receiving radios shall comprise amplifications by low noise amplifiers (LNAs) and frequency down conversions. However, as far as an individual user is concerned, the technique and configuration depicted on FIG. 6 is designed for frequency re-use in a multipath rich propagation environment. However, there are three transmit elements for 4 Tx beams in two groups. The beam grouping is aiming for two separated destinations.

The 4 shaped beams feature characteristics of performance discrimination such as those on orthogonal beams or quiet-zone. However, two beams within a group aiming for a same destination are two independent beams. Two beams in each group shall be categorized as a 2×2 MIMO. They are simply multiple SISO combined efficiently for the purposes of re-using a same frequency and/or time slot. The first “2” indicates two independent transmitting beams for transmitting while the second “2” for two elements associated with a receiver. We shall address MIMO configurations with more detailed descriptions on post processing in receivers Rx A and Rx B later.

In the following we shall use the constraints of orthogonal beams (OB beams) for “beam shaping” constraints illustrating frequency re-use functions of multiple users in MIMO communications systems. Other beam-shaping constraints including “quiet-zone” constraints may also be applicable to techniques of multiple-user (MU) MIMO. In highly structured and dynamic multipath propagation environment, those techniques implemented via quiet zone constraints over various receivers for different users may require more instantaneous constraints to a user than the number of receiving antenna elements attached to his or her receiver. On the other hand, those techniques implemented via OB constraints over various receivers for different users may require no more instantaneous constraints to a user than the number of receiving antenna elements attached to his or her receiver. It is the “cost” of relaying feedback information in back-channels which shall dictate preferences of beam shaping constraints. The information feedback “cost” includes numbers of required sensors at receivers, complexity of local processing before transporting feedback data, and required transporting communications resources such as bandwidths, time slots and/or radiated powers.

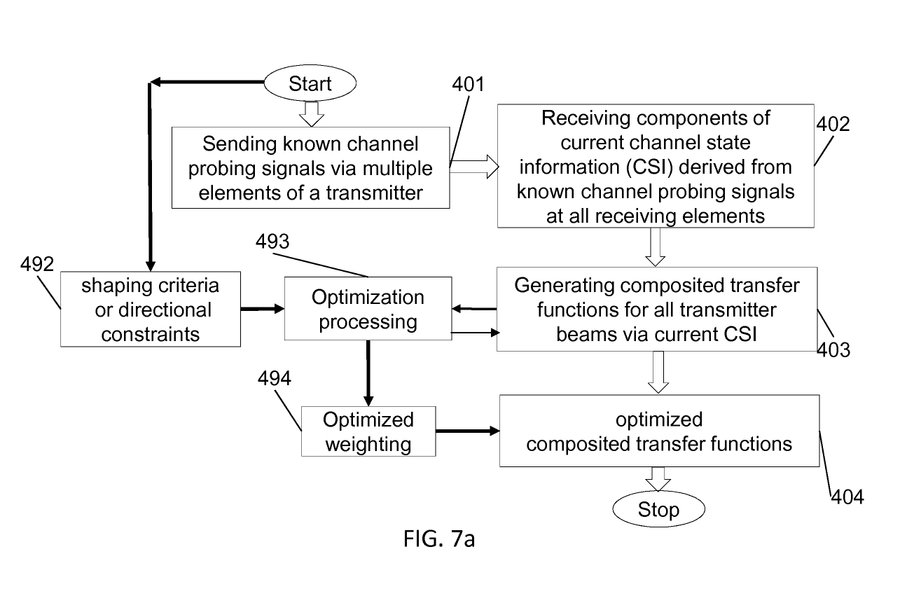

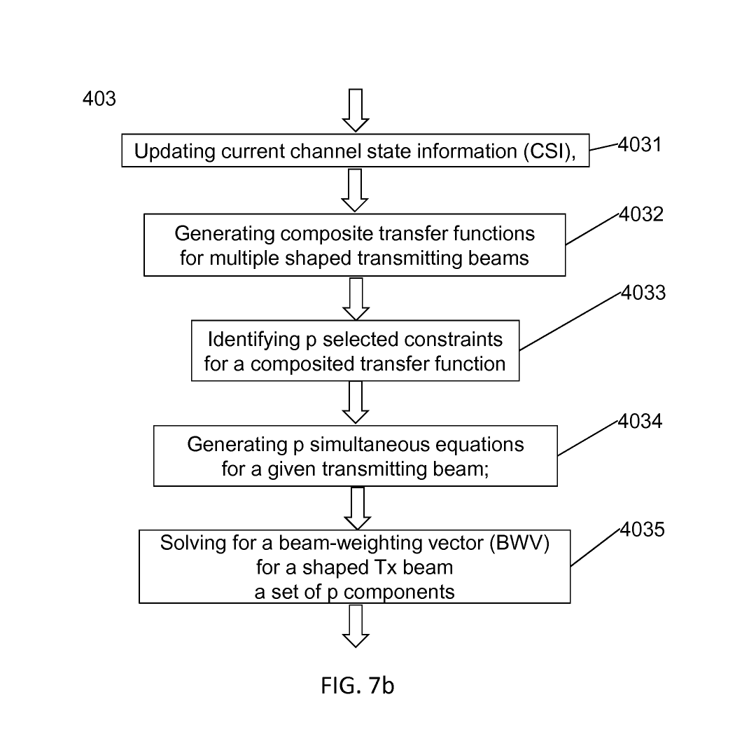

FIG. 7a depicts a flow chart with a close loop optimization for composited transfer functions; each composited transfer function shall exhibit shaped beam features. For each frame of transmissions, MIMO communications systems will monitor dynamic propagation channels and generate or update current channel state information (CSI) by sending probing signals from a transmitter through propagation channels 401 and obtaining feedback information from various receivers 402. Composited transfer functions 403 are generated by summing multiple weighted transfer functions corresponding to propagation characteristics from various transmitting elements to same sets of receiving elements on various receivers. The propagation characteristics usually include time delays, phase and amplitude changes for various signal frequency components. To optimize composited transfer functions using bean shaping techniques; a set of beam shaping criteria 492, such as OB beams and quiet-zone criteria, must be available to an optimization processor 493, which may be programmed to (iteratively) generate a set of optimized weighting coefficients 494 based on algorithms; such as cost minimization. Optimized composited transfer functions 404 usually are characterized as shaped beams with spatially sampled constraints. These transfer function constraints are measured concurrently at multiple receiving antenna elements on various receivers.

FIG. 7b depicts a detailed formulation for the box 403 in FIG. 7a. It is formulated based on a narrow band signal assumption. As a result, the weighting coefficients Wᵢ comprise only time delay, phase and amplitude components. It is based on current measured channel state information CSI 4031 from various transmitting elements to different receiving elements. A component of a composited transfer function 4032, from multiple transmit elements of a transmitter to a first receiving element, is generated via a sum of weighted transfer function; or a linear combination of selected transfer functions. The set of the weightings shall be applied to other component of the composited transfer function 4032 from the same multiple transmit elements to a second receiving element, and so on. In other words, a composited transfer function Bm with p selected constraints 4033 shall features p independent spatial samples or selected components {Bmₖⱼ};}, or

Bm={Bmₖⱼ},

where Bmₖⱼ=ΣᵢWᵢhᵢₖⱼ,
m the index for a shaped transmitting beam,
is an index for all transmit antenna elements,
and kj are the indexes for the j^{th} element of a k^{th} receiver, and the summation is operated over the entire “i”, or all transmitting elements.

As a result, every shaped beam shall be constrained by p simultaneous equations 4034. These equations are used to solve for {Wᵢ} 4035 via iterative optimization processing, direct matrix inversions or other techniques. We usually select p to be identical to number of transmitting elements. For wide band signal processing applications, the weighting shall be formulated, as an example, by finite impulse response (FIR) filters. There are many other wideband signal processing formulation/configurations as suggested in many textbooks on digital signal processing.

In the following descriptions of embodiments, we will not show feedback networks for dynamic updating channel state information (CSI) and additional ones for altering composited transfer functions (CTF). They are similar to the ones shown in FIG. 2-1 and FIG. 4. We will assume the CTFs are continuously updated via varying current BWVs to account for dynamic natures of a multipath channel. As a result, discriminative natures of the CTFs, favoring one user and against other users, are well-structured and available by controlling current BWVs. We shall focus on other aspects of various embodiments which shall take advantages of the natures of these CTFs to allow frequency reuses among multiple users in MIMO.

### Embodiment 1

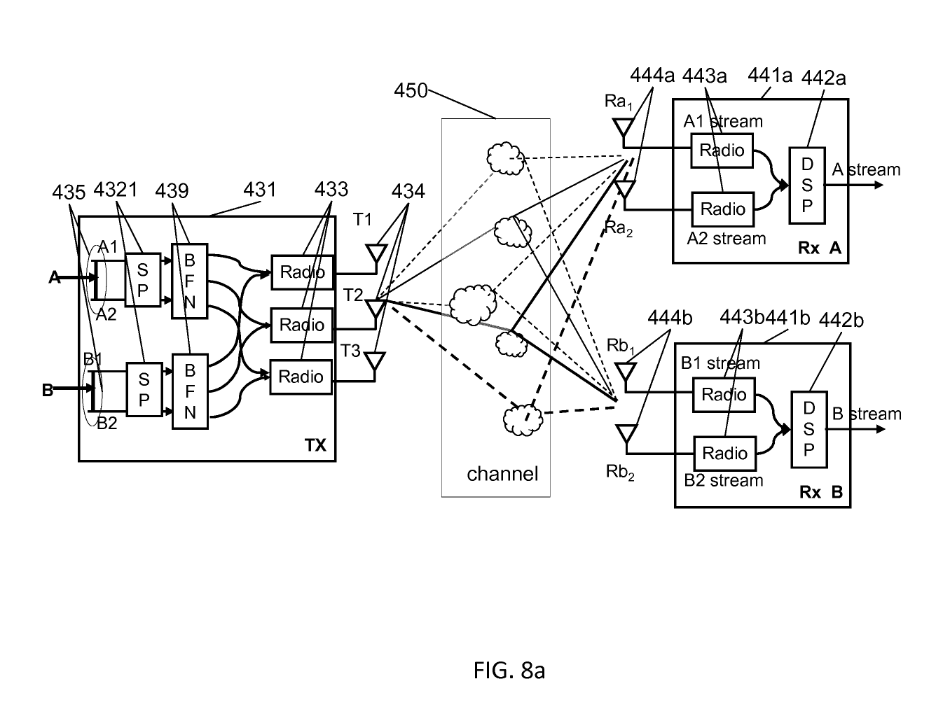

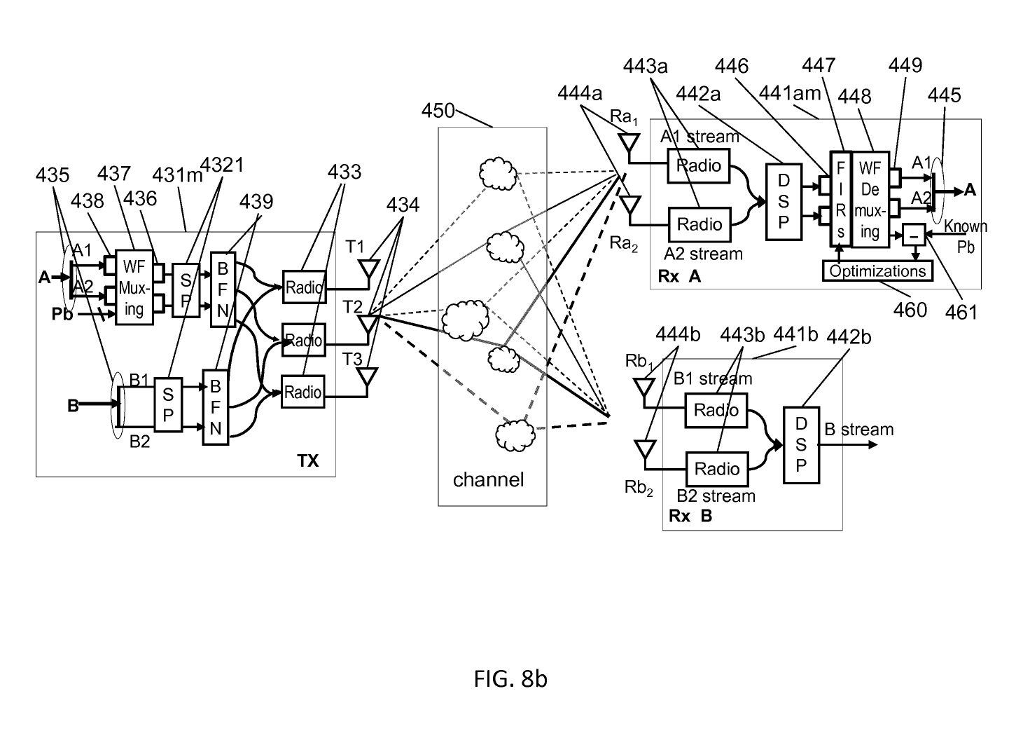

In a transmitter 431 depicted in FIG. 8a, the first input data stream, stream A, is segmented by a splitter 435 into two substreams A1 and A2; followed by a first signal processor (SP) 4321 which, among other functions, performs space-time coding. Its two outputs are sent to a first 2-to-3 beam-forming-network (BFN) 439 which performs beam-shaping processing for two concurrent beams. An assembly of a SP 4321 plus a BFN 439 features 2 inputs and 3 outputs. The first input is for a first shaped beam, (the Beam BBₐ₁ for equation (6)), and the second input is for a second shaping beam Beam BBₐ₂. The first shaped beam features (1) a peak at the first user Rx A 441a aiming to the first antenna element (Ra1) and (2) two nulls pointing to the two antenna elements 444b, Rb1 and Rb2, for the second user Rx B. The second shaped beam also features a peak at the first user Rx A 441a but aiming to the second antenna element (Ra2) and two nulls at the two elements of the antennas 444b, Rb1 and Rb2, of the second user Rx B.

The three outputs from the first 2-to-3 BFN 439 are connected to three radios 433 individually, which are followed by three transmitting antennas 434; T1, T2, and T3.

Beam B_{Ba1} is shaped and optimized as an OB beam under three constraints specified in equations 6a, 6b and 6c. The three performance constraints for Beam B_{Ba2} shall feature nulls at Rb1 and Rb2 with under constraints 12 and 13 and 214, and a peak at Ra2 location under constraint 14;

xii. |wa₁*h_{1b1}+wa₂*h_{2b1}+wa₃*h_{3b1}|=0 (9a)

xiii. |wa₁*h_{1b2}+wa₂*h_{2b2}+wa₃*h_{3b2}|=0 (9b)

$$xiv . {max}_{{wa}_{1} , {wa}_{2} , {wa}_{3}} ( \vert {wa}_{1} * {h}_{1 a 2} + {wa}_{2} * {h}_{2 a 2} + {wa}_{3} * {h}_{3 a 2} \vert ) \qquad ( 9 c )$$

With three equations of 9a, 9b and 9c (the constraints of OB beams), an optimization algorithm shall provide optimal solutions for wa₁, wa₂ and wa₃; the optimized weighting components of a beam weighting vector (BWV) for Beam BBₐ₂.

It is assumed that spacing between elements Ra₁ and Ra₂ are relatively small in comparison to those from Ra₁ or Ra₂ to Rb₁ and from Ra₁ or Ra₂ to Rb₂. Therefore, we have not imposed more stringent constraints for the example in FIG. 8a on shaped transmitting beams. Ideally more constraints should have specified that a beam with peak pointed at a first receiving element of a first user for a first shaped OB beam shall also feature nulls at all other receiving elements of the same user, and the receiving elements of all other users utilizing the same frequency slot. The fine resolutions, much finer than those derived directly for line-of-sight resolutions, are results from magnification effects due to multipath scatting mechanisms.

Referring back to FIG. 8a, the second input for the transmitter 431 data stream is, stream B, which is also segmented into two substream B1 and B2; followed by a second signal processor (SP) 4321 and then followed by a second 2-to-3 BFN 439 which, among other functions, performs beam shaping for two concurrent beams. The second assembly of a SP 4321 and a BFN 439 features 2 inputs and 3 outputs. The first input is for the Beam B_{Bb1} which features a peak aimed to the second user Rx B 441b with emphasis on the first antenna of 444b, Rb1, and two nulls at two elements Ra₁ and Ra₂ 444a of the first receiver 441a. These constraints are specified by equations similar to those in equation (8). The second input is for a second shaping beam, Beam B_{Bb2}, which features a peak aimed to the a second user Rx B 441b but to with emphasis on the second antenna of 444b, Rb₂, and two nulls at two elements Ra₁ and Ra₂ 444a for of the first receiver 441a. The three outputs of the second BFN 439 are connected to three radios 433 which are followed by three transmitting antennas 434. The 3 radios 433 and the 3 antenna elements 434 are “shared” concurrently by 4 independent transmitting beams generated and shaped by the two 2-to-3 BFNs 439. As a result, there are 4 independent wavefronts going through 3 array elements concurrently. Each wavefront corresponds to radiations from a shaped beam

Similarly, the three beam shaping constraints as an OB beam for Beam BBb₁ are specified in equations 8a, 8b and 8c. With Under the same the OB beam constraints group, the three performance constraints for Beam BB_{b2} shall feature nulls at Ra₁ and Ra₂ with constraints 15 and 16, and a peak at Rb₂ location with constraint 18;

xv. |wb₁*h₁ₐ_{₁}ₐ₁+wb₂*h₂ₐ_{₁}ₐ₁+wb₃*h₃ₐ_{₁}ₐ₁|=0 (10a)

xvi. |wb₁*h₁ₐ_{₂}ₐ₂+wb₂*h₂ₐ_{₂}ₐ₂+wb₃*h₃ₐ_{₂}ₐ₂|=0 (10b)

$$xvii {max}_{{wb}_{1} , {wb}_{2} , {wb}_{3}} ( \vert {wb}_{1} * {h}_{1 {b}_{2} b 2} + {wb}_{2} * {h}_{2 {b}_{2} b 2} + {wb}_{3} * {h}_{3 {b}_{2} b 2} \vert ) \qquad ( 10 c )$$

With the three equations of 10a, 10b and 10c, an optimization algorithm shall lead us to an optimal set of solutions for wb₁, wb₂ and wb₃ as the optimized weighting components of a beam weighting vector (BWV) for Beam BB_{b2}.

Injected signals by the three transmitting antennas 434 of the transmitter 431 will propagate through a multipath dominated communication channel 450 and arrive in a first receiver 441a at a first destination and a second receiver 441b at a second destination in parallel.

The first receiver 441a, Rx A, the two antennas 444a at connected to the first receiving splitters Rx A 441a will only capture radiated signal substream “A1” delivered by Beam BBₐ₁ and substream “A2” delivered by Beam BBₐ₂, while the two antennas 441b at for the second receiving receiver site Rx B 441b will only be accessible to radiated substream “B1” signals delivered by Beam BB_{b1} and the radiated substream “B2” signals delivered by Beam BB_{b2}. At the site of first destination Rx A 441a, the received signals by the first element, Ra₁, of two antennas 444a for the first receiver Rx A 441a, conditioned by a first one of the radios 443a, will comprise mostly information of substream A1 delivered by Beam BBₐ₁ and some leakage of substream A2 radiated by beam BBₐ₂. Similarly, the received signals by the second element, Ra₂, of two antennas 444a conditioned by a second one of the radios 443a, will comprise mostly of information of substream A2 delivered by Beam BBₐ₂ and some leakage of substream A1 radiated by Beam BBₐ₁. The functions of the DSP 442a are (1) to recover received A1 and A2 substreams by decoupling the correlations of the two received streams of data via linear combinations, and (2) combing to combine the recovered A1 and A2 substreams to reconstitute the recovered data stream “A.”

At the second destination of Rx B 441b, the received signals by the first element, Rb₁, of two antennas 444b of the second receiver Rx B 441b and conditioned by a first one of the radios 443b, will comprise mostly information of substream B1 delivered by Beam BB_{b1} and some leakage of substream B2 radiated by beam BB_{b2}. Similarly, the received signals by the second element, Rb₂, of two antennas 444b conditioned by a second one of the radios 443b, will comprise mostly information of substream B2 delivered by Beam BB_{b2} and some leakage of substream B1 radiated by Beam BBb₁. The functions of the DSP 442b are (1) to recover received B1 and B2 substreams by decoupling correlations of the two received streams of data via linear combinations, and (2) to combing combine the recovered B1 and B2 substreams to reconstitute the recovered signal data stream “B.”

### Embodiment 2

Another embodiment depicted in FIG. 8B features wavefront multiplexing (WF muxing)/de-multiplexing (demuxing). This embodiment of the MU MIMO configuration allows one receiver with conventional MIMO, and the other receiver featuring WF demuxing process for dynamic resource sharing. The only differences between FIG. 8A and FIG. 8B are (1) a suite of a wavefront multiplexing (WF muxing) processors is inserted at the transmitter 431m for signal stream “A” between a first splitter 435 and a first signal processor (SP) 4321; and (2) a suite of wavefront demultiplexing (WF demuxing) devices in inserted between a DSP 442a and a signal combiner 445a in a first receiver 441am. We shall focus on the new additions.

At the transmitting site 431m, a first signal stream, “A”, is segmented into A1 and A2 substreams by a first splitter 435; each followed by a TDM demuxer or a serial to parallel (S/P) converter 438. The outputs of the demuxer or converters, along with pilot or diagnostic are sent to an M-to-M wavefront multiplexer 437 (WF muxer) with M inputs and M outputs, where M≧3. The M outputs are grouped into two segments; each is individually multiplexed by a conventional multiplexer 436 into one wavefront multiplexed (WF muxed) data stream. The two wavefront multiplexed (WF muxed) data streams, Mux1 and Mux2, are then connected to the two inputs of the first SP 4321, followed by a first 2-to 3 BFN 439 as the ones in FIG. 8a.

The processing in the splitting segment 435 for data stream “B” is identical to that in FIG. 8a without insertion of WF muxing.

There are many choices for the WF muxing transformation 437. Orthogonal matrixes are simple because their inverse matrices are similar to the original ones. Non orthogonal matrices with existing inversed matrices may also be used for WF muxing. As an implementation example, a 256-to-256 Hadamard transform is selected as the WF muxing processor 437. The first 127 input ports are for the A1 substream after converted from a fast serial flow to 127 parallel slower flows by a first TDM demuxer as the first serial-to-parallel converter 438. Similarly the last second 127 input ports are connected to the A2 substream after converted from a fast serial flow to 127 parallel slower flows by a second TDM demuxer as the second serial-to-parallel converter 438. The middle remaining two inputs are connected to a set of probing/diagnostic signals.

The 256 outputs of the WF muxing processor 437 are 256 different weighted sums of the 256 inputs. Each input features a unique distribution of its weighting parameters, which are presented as a weighting vector with 256 components or, a wavefront vector (WFV), or simply a wavefront (WF). Signals connected to different input ports shall exhibit various distributions of their weighting parameters, or various weighting vectors or wavefronts (WFs). In fact, the 256 input ports are associated with 256 distinct wavefronts mutually orthogonal to one another. We will use the orthogonal features via probing signals in receiving, to equalize propagation channels and coherently combine received signals from multiple paths for enhanced signal-to-noise ratios of received desired signals.

A signal stream connected to one input of the WF muxing processor 437 will appear in all its outputs with a unique weighting distribution. Conversely signals from one output of the WF muxing processor 437 is a result of a linear combinations of all its input signals, which may be completely independent, unrelated, and therefore uncorrelated. After WF muxed, the 256 outputs of the WF muxing process 437 are grouped into two sets, each with 128 outputs which are multiplexed in time, frequency or coded into a single stream, Mu1 or Mu2. Each of the two streams of Mu1 and Mu2 comprise information from A1, A2, and known pilot or diagnostic signal streams, which may only use less than 1%, or 2/256, of propagation bandwidth assets. By the way, the percentage of power assets for the probing or diagnostic signals can be controlled by minimizing the input power of these probing signals in comparisons to these of desired communications data/signal streams.

As to the transmitter 431m in FIG. 8b, two independent data streams A and B are segmented individually into two sets of segmented input data substreams (A1, A2), and (B1, B2) which are processed in parallel but through different processing. The stream A is converted to substreams (A1, A2), which are further processed via a WF muxing transformation to become (Mu1, Mu2). They are spatially mapped by two SP 4321 followed by a first 2-to-3 BFN to form two optimally shaped beams with 3 common outputs, which are amplified by 3 radios 433 and then radiated through a set of 3 antennas 434. On the other hand, the stream B is converted to substreams (B1, B2). They are spatially mapped by a second SP 4321 followed by a 2-to-3 BFN for forming two optimally shaped beams with 3 common outputs, which are amplified by the same 3 radios 433 and then radiated through the same set of 3 antennas 434. The 3 radios 433 and the 3 antenna elements 434 are concurrently shared by both A and B streams. The processing after the splitting segment 435 for stream “B” is identical to that in FIG. 8a.

As to the first receiver 441amm in FIG. 8b, Rx A 441am, the two antennas 444a will only capture radiated signal WF muxed substream “Mu1” delivered by Beam BBₐ₁ and WF muxed substream “Mu2” delivered by Beam BBₐ₂. The two antennas 444a will not be accessible to radiated substream “B1” signals delivered by Beam BB_{b1} and the radiated substream “B2” signals delivered by Beam BB_{b2}. The received signals by the first element, Ra₁, of two antennas 444a conditioned by a first one of the radios 443a, will comprise mostly information of substream Mu1 delivered by Beam BBₐ₁ and some leakage of substream Mu2 radiated by beam BBₐ₂. Similarly, the received signals by the second element, Ra₂, of two antennas 444a conditioned by a second one of the radios 443a, will comprise mostly information of substream Mu2 delivered by Beam BBₐ₂ and some leakage of substream Mu1 radiated by Beam BBₐ₁. Ideally, the functions of the DSP 4421a are to recover received Mu1 and Mu2 WF muxed substreams by decoupling the correlations of the two received streams of data via linear combinations. Since Mu1 and Mu2 are heavily correlated, conventional techniques of de-correlating Mu1 and Mu2 will not work efficiently, or not as good.

We may do spatial de-mapping by the DSP 442a. However, that function is carried out as a part of equalization process by a bank of the FIR filters 447 before the WF demuxing processor 448. Since we use both (1) differences 461 between signals from received probing signal channel and known probing signals, and (2) correlations of signals between pilot probing signal ports and desired signal ports as “cost functions” in optimization 460, the adaptive FIR filters 447 with optimized weighting shall realign WF muxed components of A1 and A2 substreams continuously. All cost functions shall be positive defined, and a “current’ total cost is the sum of all “current” cost functions. At an optimized state, the total cost shall be minimized. The combing device 445a will de-segment recovered A1 and A2 substreams to reconstitute the recovered data stream “A.”

As to the second receiver Rx B 441b, the two antennas 444b will only be accessible to radiated substream “B1” signals delivered by Beam BB_{b1} and the radiated substream “B2” signals delivered by Beam BB_{b2}. Its functions are identical to the ones in FIG. 8a.

### Embodiment 3

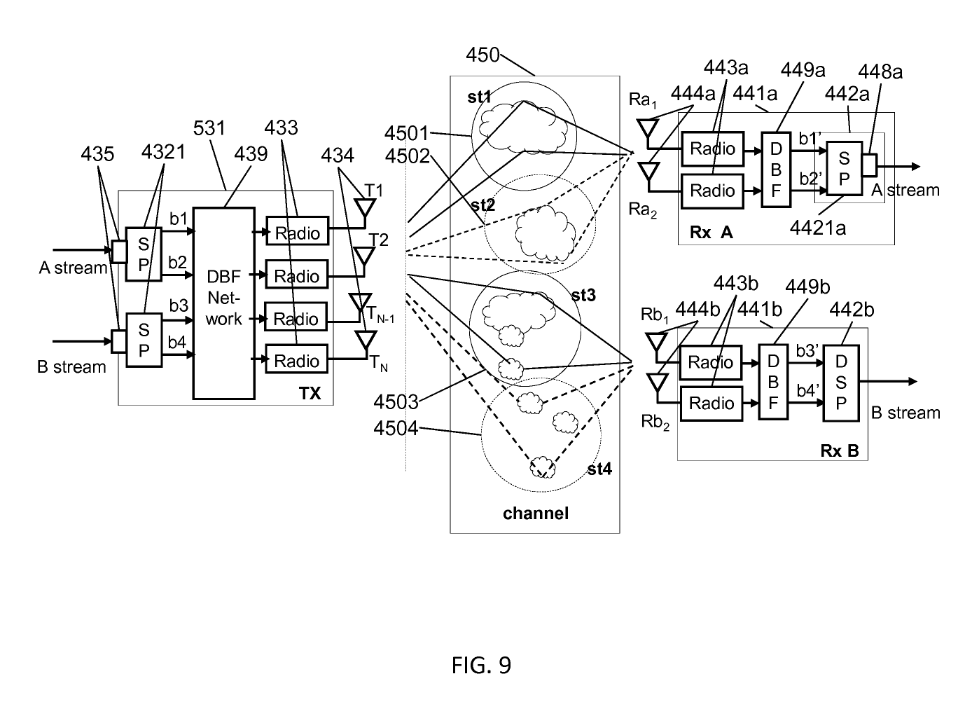

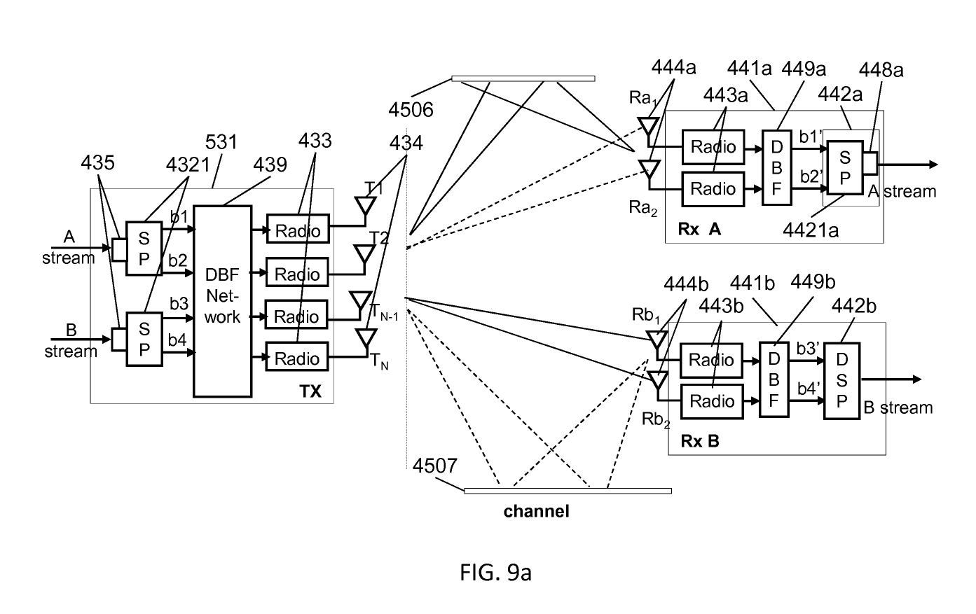

FIG. 9 depicts a third embodiment. A point to multiple-point communications system features a transmitter 531 with N transmitting (Tx) elements 434, T1, T2, T3, . . . , and TN, where N≧4, sending two data streams through a multipath dominated channel 450. There are 4 transmitting (Tx) beams formed by a multibeam digital-beam-forming (DBF) 439 processor or an equivalent focused to 4 different scattering regions 4501 4502, 4503, 4504 of a multipath dominated channel 450. The 4 beams, spot beams, shaped beams, or combinations of spot and shaped beams, are divided into two groups; 2 of the 4 Tx beams as a 1^{st} first set of Tx beams, optimized and assigned to deliver data only to a first receiver 441a, Rx A. The input ports of these two beams are indicated as “b1” and “b2”. The remaining 2 Tx beams, a second set of Tx beams, are optimized and assigned to service only a second receiver 441b, Rx B. The input ports of these two beams are indicated as “b3” and “b4”.

There are feedback networks (not shown) for dynamic updating the channel state information (CSI), which is used to calculate and update the 4 BWVs (not shown) associated with the 4 shaped dynamic beams by the DBF network 439. They are similar to the ones in FIG. 3a and FIG. 4.

A first signal stream, “A”, to be transmitted for the first receiver 441a, Rx A, is divided into two segments; substreams A1 and A2, by a first splitter 435, while a second signal stream, “B”, to be transmitted for the second receiver 441b, Rb, is divided into two segments; substreams B1 and B2, by a second splitter 435. Substreams A1 and A2 are pre-processed by a signal processor (SP) 4321, which may include coding, space-time processing and/or other formatting prior to a transmitting DBF network 439. The DBF 439 features 4 inputs and N outputs; where N≧4. There are N sets of Tx radios 433 comprising of frequency up-converters, and power amplifiers. Each may also comprise of all or part of additional modulation functions.

The transmitting system, an optimized combination of the transmitter 531 and the transmitting antennas 434, supports two receivers, Rx A 441a and Rx B 441b, each with at least two receiving beams using an array 444a or 444b with at least two Rx elements. The two elements 444a, Ra₁ and Ra₂, for the first receiver 441a, Rx A, are configured by a first receiving digital beam forming (DBF) processor 449a to efficiently capture radiated signals by the first set of Tx beams originated by the transmitter 531. Similarly, the two elements 444b, Rb₁ and Rb₂ for the second receiver 441b, Rx B, are configured by a second receiving DBF 449b to optimally capture radiated signals sent by the second set of Tx beams from the transmitter 531.

In a multipath channel 450, there are multiple scattering regions, st1 4501, st2 4502, st3 4503, st4 4504 to interact with RF waves radiated by the transmitter 531. The scattered signals from the communications channel 450 may reach different receiver elements 444a and 444b in forms of various propagating RF wavefronts (WF), which have been “optimized” by the 4 transmitting beams shaped by the DBF network 439 in the transmitter 531. Via controlling weightings on amplitude, phase and/or time-delay of elements of each individual beam in the transmitting side, spatial separations or isolations are achieved in delivering both “A” stream and “B” stream to two different users in a common time/frequency slot through 4 independently shaped wavefronts propagating through the channel 450. The transmitting system, an optimized combination of the transmitter 531 and the antennas 434, delivers the first signal, the “A” stream” to the 1^{st} first receiver Rx A with adequate isolations from the transmission of the “B” stream.

At the first receiver Rx A, with two receiving beams formed concurrently by the first receiving DBF 449a from multiple elements (Ra₁ and Ra₂) of the receiving array 444a. The radios 443a will condition the incoming received signals. The “conditioning” includes amplifying by low noise amplifiers, band-pass filtering, and frequency down conversions by other electronics accordingly. Substream A1 is “captured” and delivered only to a first beam port b1′ of the receiving DBF 449a and substream A2 only to a 2nd second beam port b2′ of the DBF 449a. The DSP 442a performs “de-correlation” functions between b1′ and b2′ substreams by a signal processor (SP) 4421a and combining combines by a de-segmenting device 448a the de-correlated two substreams into a reconstituted data stream “A”.

Similarly, the transmitting system, an optimized combination of the transmitter 531 and the transmitting antennas 434 will concurrently deliver signals to the second receiver Rx B. The receiver will generate two receiving beams concurrently via a second DBF 449b from the array 444b with multiple array elements (at least two); Rb₁ and Rb₂. Data substream B1 will be received only to a first beam port b3′ and data substream B2 only to a 2nd second beam port b4′ of the second receiver Rx B. Concurrent users are spatially isolated by various beams focused on different scattered regions in the same propagation channel by shaped beams in both transmitting and receiving sides.

The second receiver 441b features identical functions to those of the first receiver 441a. The radios 444b will condition received signals, and the DBF 449b performs beam forming functions for two separated received beams. The DSP 442b performs both de-correlation and combining functions. Spatial de-mapping functions are carried out by combinations of the DBF 449b and the DSP 442b.

FIG. 9a is a special case of FIG. 9. The transmitter and the two receivers are identical to those in FIG. 9. Multi-paths in the propagation channels 450a (not shown) are mainly due to reflections of two walls, 4506 and 4507. This simplified geometry is to describe multipath RF propagations between high rise buildings in a city, or to model RF propagations of multipaths inside a shopping mall. There are 4 separated beams by the transmitter 531; a first set of two beams for receiver Rx A 441a, and a second set of the other two beams for receiver Rx B 441b. The two transmitting beams in the first set to Rx A 441a feature a first beam with a line-of-sight (LOS) connection and a second beam with a specular reflection in propagation by a first wall 4506. Similarly, the two transmitting beams in the second set to Rx B 441b feature a third beam with a LOS propagation and a fourth beam with a specular reflection in propagation by a second wall 4507.

### Embodiment 4

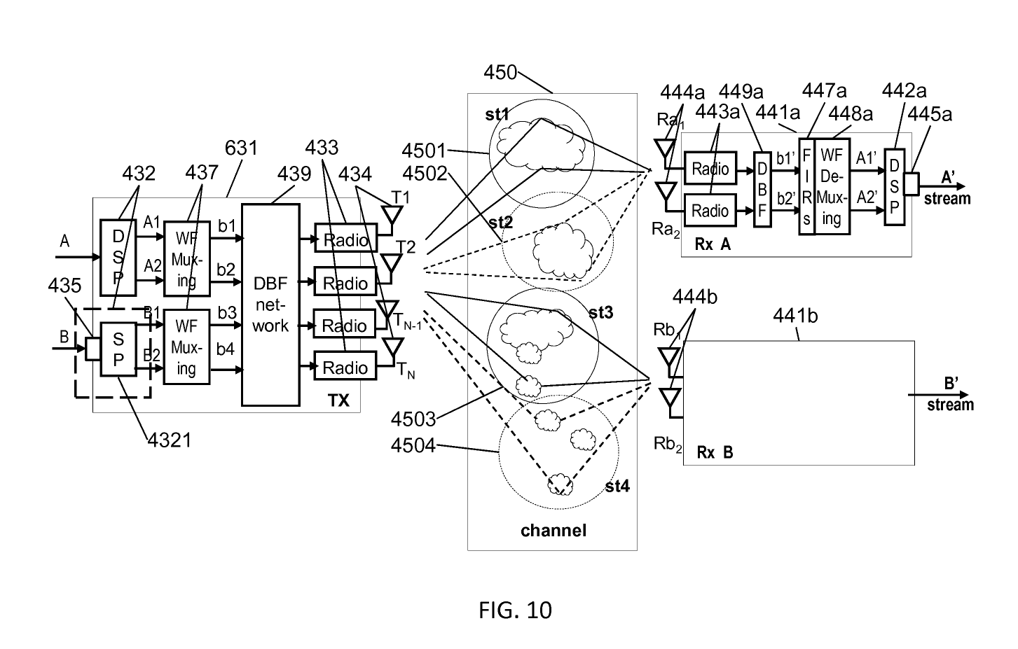

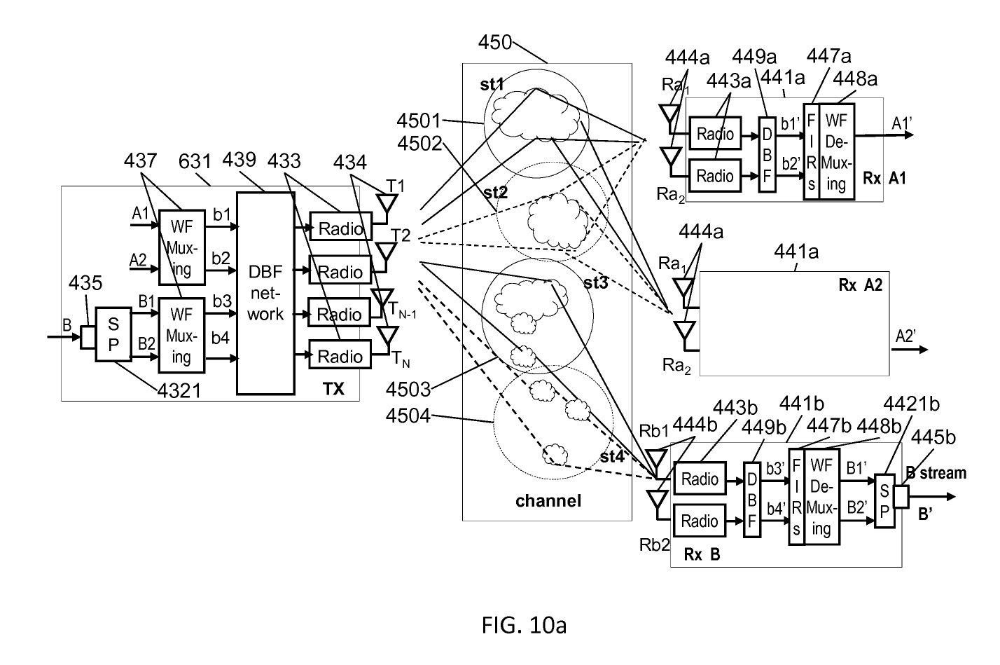

FIG. 10 depicts a multi-user MIMO configuration with wavefront (WF) multiplexing (muxing)/de-multiplexing (demuxing) for efficient dynamic resource allocations. To highlight the key architecture features, we have omitted implementation circuits for updating measured CSI in feedback networks and simplified WF muxing/demuxing circuits without depicting optimization loops in receivers for path calibrations and equalizations. Optimization, probing/diagnostic signal injection to the WF muxing/demuxing, and Input/Output (I/O) port mapping have been discussed extensively in FIG. 8b. Similar implementation techniques (not shown) are applied in here.

As depicted in FIG. 10, the transmitter 631 features 2 input data streams A, and B, as well as two WF muxing processors 437. The depicted configuration enables data transporting from a transmitter to two users via a fixed allocated spectrum which is re-used four times. The allocated spectrum will be used twice for transporting stream A, and another two folds for transporting stream B concurrently. However, there are no mechanisms for bandwidth sharing among the two users; each features a 2× frequency reused through 2 sets of shaped beams.

Signals for the first user, Rx A are designated as stream A; which are segmented in a DSP 432 into two substreams A1 and A2. They are then WF muxed via a first WF muxing device 437, same as the one in FIG. 8b. The two aggregated outputs of the WF muxing device 437 are sent to first two inputs of a multiple beam DBF network 439. Concurrently, stream B for delivering to the second user Rx B is segmented into two substreams B1 and B2 by a divider 435 and mapped spatially by a signal process processor 4321, and then WF muxed by a second WF muxing device 437 before sent to the last two inputs of the 4-to-N DBF network 439. There are N corresponding transmitting elements 434 following N radios 433, each of which performs a frequency up conversion and RF power amplification functions. A DSP 432 comprises of a SP 4321 and a splitter 435.

As depicted in FIG. 10, the 4 beams are configured to target 4 different regions; st1 4501, st2 4502, st3 4503, and st4 4504. Feedback networks (not shown) updating CSI are used to optimize the BWVs of the DBF network 439 for the four shaped transmit beams in some embodiments. The concepts of OB beams, quiet zones, or combinations of both as shaping criteria are implemented in DBF networks 439 as good options in simplifying the configuration; such as replacing the spatial mapping functions and thus eliminating the need for the SP 4321. Two of the 4 targeted scattering regions, st1 4501 and st2 4502, are for the first receiver Rx A 441a. The remaining two, st3 4503 and st4 4504, are for the second user Rx B 441b. These four scattering regions may be completely disjoint in some embodiments, or significantly overlapped in other embodiments.

The two receivers Rx A, and Rx B respectively shall feature same hardware but with software programmed to various configurations, with at least two receiving elements. As shown in Rx A 441a, each of the element is followed by a receiving radio 443 before a digital beam forming (DBF) network 449a. The DBF 449a features two output ports, connected to inputs of a WF de-muxing processor 448a after a bank of equalizers 447a dynamically compensating for differentials on time delays, phases and amplitudes among propagations in various scattering regions 4501 and 4502 of the multi-path channel 450. Associated optimization loops for the two receivers are not shown. They shall be identical to the one shown in FIG. 8b. Furthermore for the first receiver, Rx A, the recovered signals of A1′ and A2′ are the output of the first and the second outputs of a WF demuxer 448a. The DSP 445a will perform additional spatial de-correlation functions among the A1′ and A2′, which are aggregated by a TDM muxer or a parallel-to-series converter 455a to become a reconstituted signal stream A′, a recovered “A” stream.

The second receiver, Rx B, 441b with at least two receiving elements 444 b is identical to the first receiver Rx a 441a, but is configured to receive streams scattered from st3 4503 and st4 4504 which are then WF demuxed into the two recovered substreams B1′ and B2′ in reconstituting B′, the recovered stream B.

FIG. 10a features a modified configuration serving three users as compared to that in FIG. 10. As depicted, the transmitter 631 is configured to support 3 input streams A1, A2, and B, with two WF muxing processors 437. The configuration enables data transporting from a transmitter to three users via an allocated spectrum used four times concurrently. The first and second users need dynamic bandwidth allocations to accommodate their dynamic requirements. The third user for receiving a third stream B requires about twice the averaged bandwidth as those of A1 and A2 in transmissions. As a result, an allocated spectrum will be used twice for transporting stream B; and another two folds for transporting A1 and A2 concurrently.

Signals for the first two users, Rx A1 and Rx A2 are designated as A1 and A2. They are WF muxed via a first WF muxing device 437, same as the one in FIG. 8b, and two aggregated outputs of the WF muxing device 437 are sent to first two inputs of a multiple beam DBF network 439. Concurrently, the sb for the third user Rx B is segmented into two substreams sb1 and sb2 by a divider 435 and mapped spatially by a signal processor (SP) 4321, and then WF muxed by a second WF muxing device 437 before sent to the last two inputs of the 4-to-N DBF network 439. There are N radios 433, each of which performs a frequency up conversion and RF power amplification functions, and followed by a corresponding transmitting element

The 4 beams shall target 4 different regions: st1 4501, st2 4502, st3 4503, and st4 4504. The concepts of OB beams and quiet zones as shaping criteria may be implemented in the DBF networks 439 as good options in simplifying the configuration such as replacing the spatial mapping functions and thus eliminating the need for the SP 4321. Two of the 4 targeted scattering regions, st1 4501 and st2 4502, are for the first receiver Rx A1 441a and the second receiver Rx A2 441a. The remaining two, st3 4503 and st4 4504, are for the third user Rx B 441b. The three receivers depicted as Rx A1, Rx A2, and Rx B respectively shall feature same hardware with software programmed to various configurations as indicated.

Rx A1 and Rx A2 441a shall have at least two receiving elements, Ra₁ and Ra₂ followed by receiving radios 443a before a digital beam forming (DBF) network 449a. The DBF 449a features two output ports, connected to inputs of a WF de-muxing processor 448a after a bank of equalizers 447a dynamically compensating for differentials on time delays, phases and amplitudes among propagations in various scattering regions 4501 and 4502 of a multipath dominated channel. Associated optimization loops for the two receivers are not shown. They shall be identical to the one shown in FIG. 8b. Furthermore, the recovered signals of A1′ and A2′ are the first and the second outputs of a WF demuxer 448a. However, there are two separated WF demuxers 448a belonging to two spatially separated receivers, but they are configured identically except assigned output ports.

The third receiver Rx B 441b shall have at least two receiving elements 444b, each followed by a receiving radio 443b, before a receiving digital beam forming (DBF) network 449b with two output ports. The radios 443b will condition captured or received signals by associated elements. The outputs of the DBF 449b (b3′ and b4′) are received signals from two shaped receiving beams and are connected to inputs of a WF de-muxing processor 448b after a bank of equalizers 447b. They are dynamically configured to compensate for differentials on time delays, phases and amplitudes among various scattering regions st3 4503 and st4 4504 of in a multipath channel 450. The two outputs, B1′ and B2′, of the WF demuxing device 448b are sent to a signal processor (SP) 4421b for further spatial de-mapping 4421b before de-segmenting by a combiner 445b in reconstituting the recovered stream B from the two recovered substreams B1′ and B2′.

### Embodiment 5

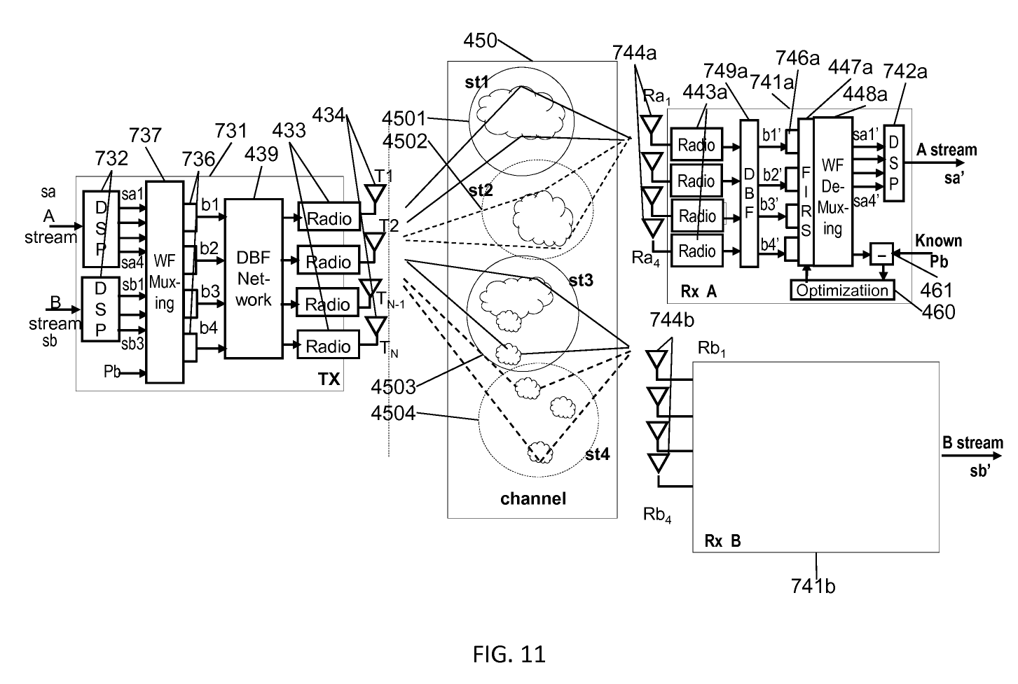

FIG. 11 depicts another multi-user MIMO configuration with wavefront multiplexing/de-multiplexing (WF muxing/demuxing) for efficient dynamic resource allocations. To highlight the key architecture features, we do not show circuits for updating measured CSI in feedback networks. The transmitter 731 features 2 input data streams, A stream (sa) and B stream (sb), as well as one 8-to-8 WF muxing processors 737. The configuration enables data transporting from a transmitter to two users via an allocated spectrum used four times concurrently. Both users need dynamic allocations to accommodate their bandwidth and radiated power or EIRP requirements. The dynamic allocations are under constraints of constant resources on total bandwidth and on total radiated power. As a result, an allocated spectrum will be re-used four times for transporting both the sa and sb concurrently. It may assign all 4× bandwidth to sa in one instance, and to sb in a second instance. It may also 50% resources to both sa and sb in a third instance, and 90% to sa and 10% to sb in a fourth instance.

As depicted in FIG. 11, signals for the two users, Rx A and Rx B, designated as sa and sb are dynamically segmented into total 7 segments via two DSP 732, 4 for sa and 3 for sb at one instance. They distribution may become 6 for sa and 1 for sb at a second instance, or 0 for sa and 7 for sb at a third instance, and so on. The 7 substreams are connected to 7 of the 8 inputs of the 8-to-8 WF muxing processor 737. The remaining input is used for probing or diagnostic signals, denoted as Pb. As depicted, the first 4 input ports are for stream A (sa), the second 3 input ports for stream B (sb), and the last input port for Pb. The 8 outputs are grouped into 4 groups via a bank of 4 multiplexers 736 (e.g. TDM muxers); each group is connected to an input of a 4-beam DBF 439 which features N outputs; followed by a bank of radios 433 for signals frequency up-conversion and power amplification before individually radiated by N transmitting elements 434.

There shall be 4 shaped beams generated concurrently by the DBF 439; each may be dynamically and individually optimized via updating an associated Beam-Weight-Vector (BWV) in some embodiments based on updated CSI by feedback networks (not shown). In other embodiments the associated BWV are periodically or occasionally updated when multipath dominated communications channels are nearly stationary. It is clear that there are other arrangements for the input signals via the same WF muxing transform. In facts there exists 8!, or 40,320, possible input arrangements for any 8-to-8 WF muxing processor such as the one 736 shown in here. The high number of possible input arrangements may be taken advantages of as part of transmission privacy.

Signals from any one of the 8 output ports of the WF muxing transform 737 are results of a unique linear combination (or a weighted sum) of all 8 independent signals connected to the 8 input ports. Furthermore, signals connected to any one of the 8 input ports will appear in every one of the 8 outputs, as parts of aggregated signals. Consequently, each of the 8 inputs of the WF muxing processor 737 is associated with a distribution of 8 weighting parameters among the 8 output signals (or 8 linear combinations). The distribution of 8 weighting parameters is also referred as a wavefront vector (WFV) with a dimension of 8 or simply as a wavefront (WF). There shall be 8 WF vectors associated with the WF muxing transform 737. These WF vectors will be mutually orthogonal only when the 8-to-8 WF muxing transform 737 is implemented by an orthogonal matrix such as an 8-to-8 FFT, an 8-to-8 Hadamard matrix, a 2×x4-to-2×x4 Hadamard Matrix, or Cascaded FFT and Hadamard matrices; and many others.

As depicted, the 4 beams shall target 4 different regions, st1 4501, st2 4502, st3 4503, and st4 4504. Some of the targeted regions may be significantly overlapped from one another. Furthermore, feedback networks (not shown) updating CSI will be used to optimize the BWVs for the four shaped transmit beams in some embodiments. The concepts of OB beams, quiet zones, or combinations of both as shaping criteria may be implemented in the DBF networks 439. All 4 targeted scattering regions, sp1 st1 4501, sp2 st2 4502, sp3 st3 4503 and sp4 st4 4504, are for both users with receivers Rx A 741a and Rx B 741b, respectively, which shall feature same hardware but with software programmed to various configurations as indicated. The first user shall have at least four receiving elements 744a, followed by receiving radios 443a before a digital beam forming (DBF) network 749a. The DBF 749a features four output ports, connected to inputs of a 8-to-8 WF de-muxing processor 448a after a bank of de-multiplexers 746a and adaptive equalizers 447a which dynamically compensating for differentials on time delays, phases and amplitudes among propagations in various scattering regions 4501 to 4504 of a multi-path channel 450. The first 4 of the 8 outputs from the WF demuxing processor 448a are allocated for the first data stream sa for the first receiver, Rx A 741a.

One output of the WF demuxer 448a is compared to a known probing signal Pb. The differences 461 are indexed as cost functions for an optimization processor 460 to calculate weighting parameters for the bank of equalizers 447a. The detailed processing shall be identical to the one shown in FIG. 8b. At an optimized state of the equalizers the assigned first 4 outputs of the WF demuxer 448a will recover the 4 substreams sa1′, sa2′, sa3′, and sa4′. The de-segmenting unit DSP 742a will perform spatial de-mapping further before combining all 4 substreams (sa1′ sa2′, sa3′, and sa4′) into a reconstituted stream A or sa data.

Furthermore, the second receiver, Rx B 741b features identical functions as those in the first receiver, Rx A 741a. It shall have at least four receiving elements 744 b. However, a WF demuxer is configured identically to the one 448a except assigned output ports. Three outputs of the associated WF demuxing device 448b are sent to a digital signal processor (DSP) 742b for further spatial de-mapping and de-segmenting of the three recovered substreams sb1′ sb2′ and sb3′ in reconstituting the recovered stream B, or sb.

One way of examining operating flexibility on a selected configuration as depicted in FIG. 11 is to double the total frequency reuse for the two users from 4 folds (4×) to 8 folds (8×). The modifications include the following;

For the transmitter 731,
1. For the DSPs 732 for the A and B streams, increasing its processing clock rate to 200% of the current rate
2. for the WF muxer 736
   1. Clocking the 8-to-8 WF muxing processor at a rate of 200% of the current clock rate
   2. With 8 outputs instead of 4 separated groups.
3. to replace the 4-to-N DBF network 439 to a 8-to-N DBF network for forming 8 shaped beams to illuminate the multipath channel currently
   1. to reshape the 8 beams accordingly
   2. focusing on 8 separated scattering regions; 4501 to 4504 and 4 new ones (not shown). The minimum number of the transmitting elements shall be 8.

For receivers 741
1. To increase a minimum number of receiving elements 744 from 4 to 8
2. To modify the DBF 749 accordingly to form at least 8 shaped receiving beams, which shall cover the 8 scattering regions; 4501 to 4504 plus the 4 new ones, from the propagation channel 450 illuminated by the 8 optimally shaped Tx beams.
3. For the bank of equalizers 447 and WF demuxer 448
   1. To regrouping the 8 inputs from 4 groups to 8 individually according to the grouping configuration in the WF muxer 439
   2. Clocking at 200% of the clock rate for the demuxer.

### Embodiment 6

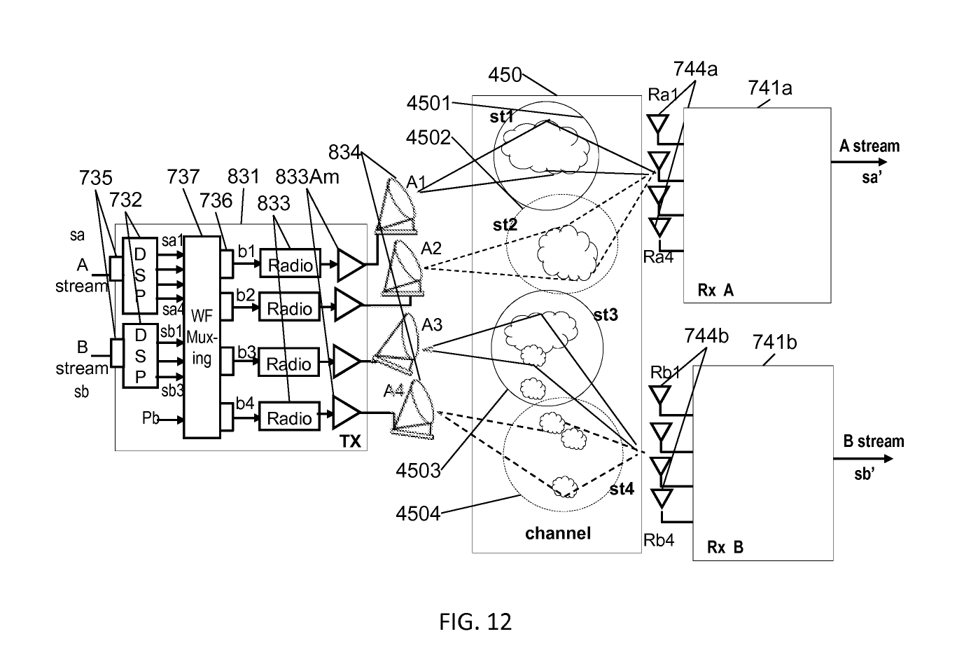

FIG. 12 depicts another multi-user MIMO configuration with wavefront multiplexing/de-multiplexing (WF muxing/demuxing) for efficient dynamic resource allocations. To highlight the key architecture features, we do not show circuits for updating measured CSI in feedback networks. The transmitter 831 features 2 input data streams, A stream (sa) and B stream (sb), as well as one 8-to-8 WF muxing processors 737. The configuration enables data transporting from a transmitter to two users via four times (4×) re-used of an allocated spectrum. Four beams are generated concurrently by 4 high gain antennas 834 which may pointing to various portions of the propagation channel 450. Both users need dynamic allocations to accommodate their bandwidth and radiated power or EIRP requirements. The dynamic allocations are under constraints of constant resources on total bandwidth and on total radiated power.

In comparison to the configuration in FIG. 7, the propagation channel 450 and the receivers 741a and 741b in FIG. 12 are identical to those in FIG. 11. We will not repeat descriptions on these items here, and will focus on differences in the transmitter 831 in FIG. 12 and the one 731 in FIG. 11. The mechanisms of forming 4 shaped beams, amplifying signals, and radiating amplified signals comprise of a 4-to-N DBF 439, N radios 433, and N antenna elements 434 in FIG. 11. Different antenna elements feature various low gain and broad beam radiation patterns. On the other hand in FIG. 12, there are no beam-forming mechanisms depicted except geometries of the 4 high gain radiators 834: A1, A2, A3, and A4. It is assumed that the beam shaping associated with a high gain radiator, such as a reflector antenna, are through many conventional techniques such as mechanical shaping of reflector surface, and/or via feed array with multiple elements near a focal region and combined by a configurable beam forming network. Therefore, the high gain radiators 834 feature dynamic beam shaping capability.

To emphasize beam forming mechanisms are after power amplification in a transmitting chain, we have separately inserted a power-amplifier 833Am after each radio 833.

As depicted on the transmitter 831 in FIG. 12, signals for the two users, Rx A and Rx B, designated as sa and sb are dynamically segmented into total 7 segments via two DSP 732; 4 for sa and 3 for sb at one instance. The distribution may become 6 for sa and 1 for sb at a second instance, or 0 for sa and 7 for sb at a third instance, and so on. The 7 substreams are connected to 7 of the 8 inputs of the 8-to-8 WF muxing processor 737. The remaining input may be used for probing or diagnostic signals, denoted as Pb.

As depicted, the first 4 input ports are for stream A (sa), the second 3 input ports for stream B (sb), and the last input port for Pb. The 8 outputs are grouped into 4 groups via a bank of multiplexers 736 (e.g. TDM muxers); each group is connected to an input of a high gain radiator 834 after frequency up-converted by a radio 833 and amplified by a power amplifier 833Am. The 4 beams are targeted 4 different regions, st1 4501, st2 4502, st3 4503, and st4 4504, which may be significantly overlapped among one another. Furthermore, feedback networks (not shown) updating CSI will be used to optimize the four shaped transmit beams. The configurations of OB beams, quiet zones, or combinations of both as shaping criteria are implemented through mechanisms in the high gain radiators.

All 4 targeted scattering regions, st1 4501, st2 4502, st3 4503 and st4 4504, are accessible by both receivers Rx A 741a and Rx B 741b, respectively, which shall feature same hardware with software programmed to various configurations as indicated. They shall be identical to the ones in FIG. 11.

### Embodiment 7

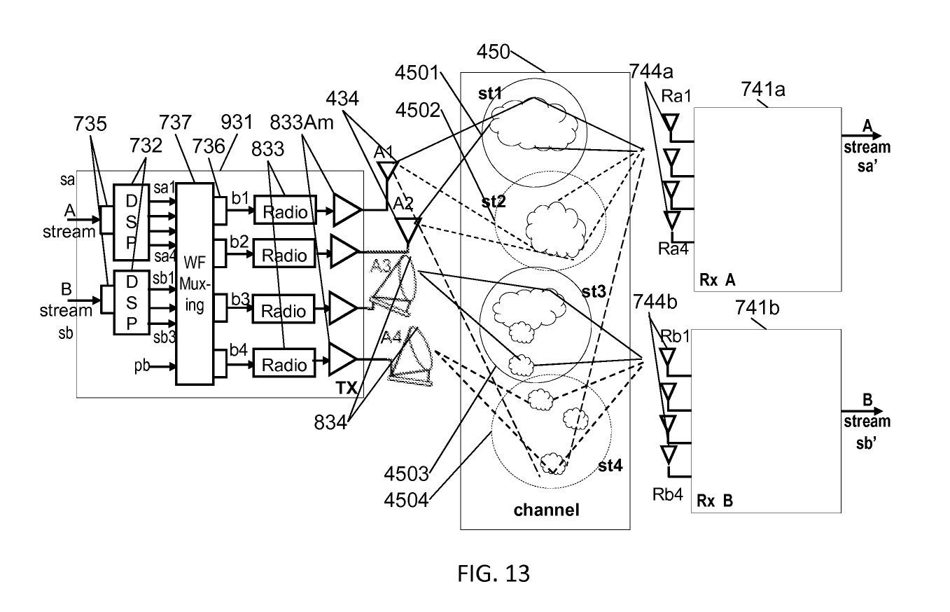

FIG. 13 depicts another multi-user MIMO configuration with wavefront multiplexing/de-multiplexing (WF muxing/demuxing) for efficient dynamic resource allocations. To highlight the key architecture features, we do not show circuits for updating measured CSI in feedback networks. The transmitter 931 features 2 input data streams, A stream (sa) and B stream (sb), as well as one 8-to-8 WF muxing processors 737. The configuration enables data transporting from a transmitter to two users via an allocated spectrum used four times concurrently. The four beams are generated by 4 antennas 434 and 834 pointing to illuminating various portions of the propagation channel 450. The first two elements 434, A1 and A2, feature radiation patterns of low gain and wide angular coverage; and the remaining two 834, A3 and A4, are high gain, spot of shaped “spot” beam antennas. As a result, there are two shaped beams, and another two low gain beams injected from various element positions.

Both users need dynamic optimal allocations on communications assets to accommodate their dynamic bandwidth and radiated power or EIRP requirements. The dynamic allocations are under constraints of constant resources on total bandwidth and on total radiated power. An allocated spectrum will be re-used four times efficiently for transporting both the sa and sb concurrently.

In comparison to the configurations in FIG. 7 and FIG. 12, the propagation channel 450 and the receivers 741a and 741b in FIG. 13 are identical to those in FIG. 11 and those in FIG. 12. We will not repeat descriptions on these items again in here, and focus on the transmitter 931 in FIG. 13. The mechanisms of forming 4 shaped beams, amplifying signals and radiating power-amplified signals in FIG. 11 comprise of a 4-to-N DBF 439 followed by N radios 433, and N transmitting antenna elements 434. Each antenna features a low gain and broad beam radiation pattern. On the other hand, beam forming and shaping mechanisms are implicitly included in the 4 high gain radiators 834 in FIG. 12. On the other hand in FIG. 13, the four radiators are elements A1, and A2 featuring low gain broad beams; and the other 2 antennas A3, and A4 featuring high gain shaped beams. Separately power-amplifier stage 833Am are inserted in between each of the 4-radios 833 and the transmitting antenna elements 434 and 834. There are different elements in the transmitting antenna array. There are no dynamic beam shaping from transmitting site.

As depicted in the transmitter 931, signals for the two users, Rx A and Rx B, designated as sa and sb are dynamically segmented into total 7 segments via two DSP 732, 4 for sa and 3 for sb at one instance. They distribution may become 6 for sa and 1 for sb at a second instance, or 0 for sa and 7 for sb at a third instance, and so on. The 7 substreams are sent to 7 of the 8 inputs of the 8-to-8 WF muxing processor 737. The 8 outputs are grouped into 4 streams via a bank of multiplexers 736; each group is connected to an input of an antennas 434 or 834 after frequency up-converted by a radio 833 and amplified by a power amplifier 833Am. Beam shaping, not shown, are implemented only in the 2 high gain radiators 834 A3 and A4 such as reflectors. As to A1 and A2 antennas 434, there are no shaping mechanisms for individual elements. Their radiations from different element positions shall flood the multi-path dominated channel nearly uniformly across full hemisphere.

Receiving operations at both Rx A in a first destination and Rx B in a second destination are implemented to concurrently recover multiple signal streams, respectively. Their hardware are identical to the ones in FIG. 12, but shall be software programmed to various configurations optimizing the propagation effects from the multipath communications channels 450 by taking advantage of individual array geometries and associated beam forming capability.

However, as a result of scattering from combinations of two high gain narrow illuminations, and two low gain broad beam radiations from the transmitter antenna array, the scattered composited distributions shall become highly directional, dependent on receivers in various destinations. As to details of the first receiver Rx A 741a which is identical to the one depicted in FIG. 12, a de-mapping optimization among 4 inputs, after DBF 449 in a form of 4 shaped beams, will be accomplished as a part of equalization by a bank of FIR filters 447a. Therefore an algorithm in the iterative optimization 460 shall include results of “de-mapping” as portions of feedbacks. One such feedbacks in Rx A 741a may be indices indicating the “cross correlations” among substream outputs (sa1 ‘, sa2’, sa3′, and sa4′), and those of the probing signal Pb(t) with the substream outputs.

Similarly, feedbacks in Rx B may include indexes indicating the “cross correlations” among substream outputs; which belong to a different set of assigned output ports of the WF demuxer for the recovered substreams sb1′, sb2′ and sb3′; and those with the probing signal Pb(t).

### Embodiment 8

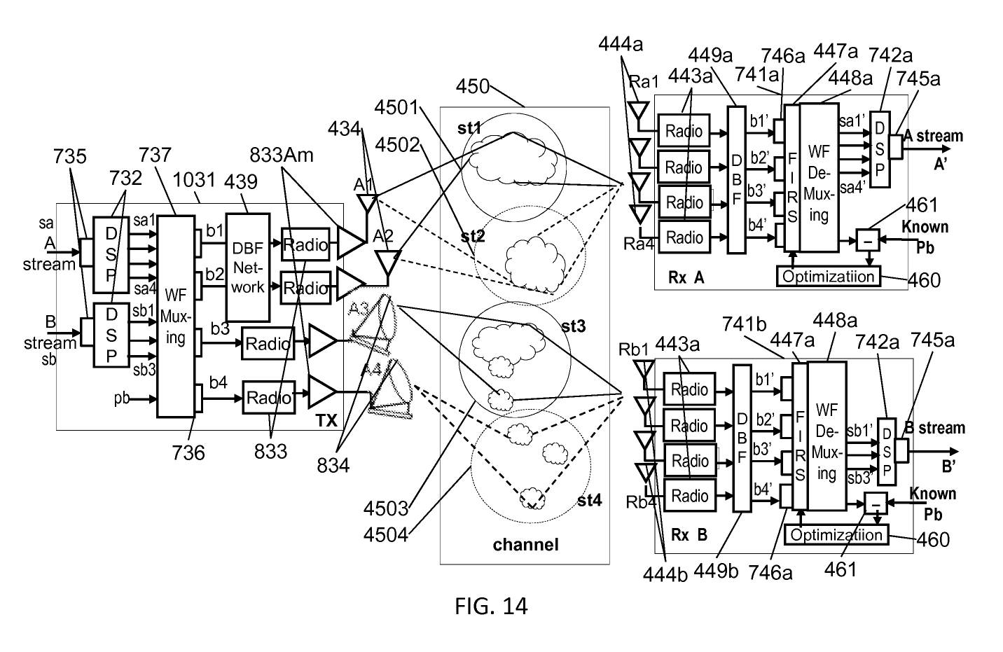

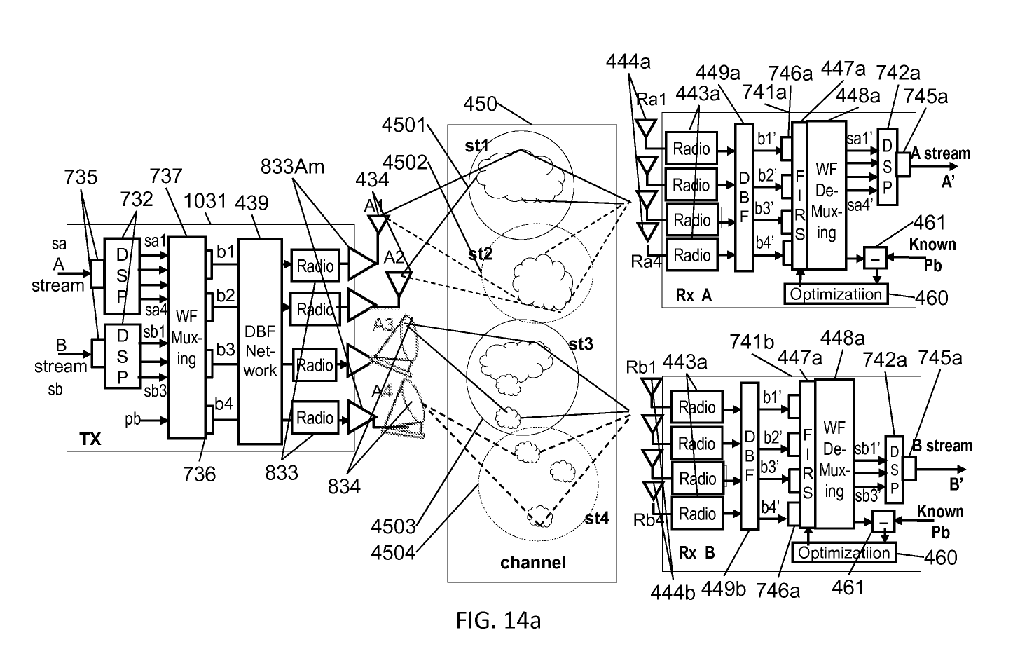

FIG. 14 depicts another multi-user MIMO configuration with wavefront multiplexing/de-multiplexing (WF muxing/demuxing) for efficient dynamic resource allocations. To highlight the key architecture features, we do not show circuits for updating measured CSI in feedback networks. The transmitter 931 1031 features 2 input data streams, A stream (sa) and B stream (sb), which go through a common 8-to-8 WF muxing processors 737. The configuration enables data transporting from a transmitter to two users via an allocated spectrum re-used four times concurrently. The four beams are generated by antennas 434 and 834 pointing to various portions of the propagation channel 450. Both users need dynamic allocations to accommodate their bandwidth and radiated power or EIRP requirements. The dynamic allocations are under constraints of constant resources on total bandwidth and on total radiated power. As a result, an allocated spectrum will be used four times efficiently for transporting both the sa and sb concurrently.

In comparing comparison to the configurations in FIG. 9, the propagation channel 450 and the receivers 741a and 741b in FIG. 14 are identical to those in FIG. 13. In fact, those three items in FIG. 7, FIG. 12, FIG. 13, and FIG. 14 are all identical. We will not repeat descriptions on these items again in here. We shall focus on the transmitter 1031 in FIG. 14.

There are two different sets of beam forming/shaping mechanisms among the 4 radiating elements in FIG. 14. A DBF network 439 inserted in between the first two bundled outputs from the WF muxer 737 and the two radios 833 associated with first two low gain radiating elements 434 forms multiple dynamic beams. Depending on the spacing between the elements and associated beam weight vectors, there will be at least two shaped beams generated. On the other hand, the transmitting patterns from the other 2 antennas A3, and A4 834 shall feature high gain shaped beams. The dynamic beam shaping mechanisms, not shown, are implicitly assumed in the high gain beam shaping radiators A3 and A4 834. We have also separately added a power-amplifier stage 833Am in each of the 4-radios 833.

As depicted in the transmitter 1031 in FIG. 14, signals for the two users, Rx A and Rx B, designated as A and B streams are dynamically segmented into total 7 segments via two DSP 732; 4 segments or substreams for stream A (sa) and 3 for stream B (sb) at one instance. The distribution may become 6 for sa and 1 for sb at a second instance, or 0 for sa and 7 for sb at a third instance, and so on. The 7 substreams are sent to 7 of the 8 inputs of a 8-to-8 WF muxing processor 737. The remaining input may be used for probing or diagnostic signals, denoted as Pb. As depicted, the first 4 input ports are for stream A (sa), the second 3 input ports for stream B (sb), and the last input port for Pb. The 8 outputs are grouped into 4 output signal streams via a bank of multiplexers 736. Each output signal stream, or a WM muxed signal stream, is sent to an input of one shaped beam. The WF muxed signals for the first two shaped beams are sent to a transmit DBF 439, frequency up-converted by a set of two radios 834, amplified by two power amplifiers 833Am and then radiated by A1 and A2 elements 434 of the antenna array. The other two beams are radiated by A3 and A4 834 of the antenna array after frequency up-converted by another set of two radios 833 and amplified by 2 power amplifier 833Am. Beam shaping for the 2 high gain radiators A3 and A4 834 are through techniques of beam forming networks (‘not shown’) or customized reflector mechanical surface contours.

In other embodiments, the 4 elements of 434 and 834 in FIG. 14 may feature 4 different element patterns, and 4 shaped beams are results of various configurable linear combinations of the 4 element beams by a multibeam beam forming network or equivalents, implemented by analogue and/or digital devices/circuits. One such embodiment is shown in FIG. 14a. Four shaped beams are implemented by a 4-to-4 transmitting DBF network 439, similar to the one in FIG. 14 but reprogrammed to feature 4 inputs (beam ports) and 4 outputs (element ports). The remaining portions of the configuration are identical to those in FIG. 14.

It is noticed that the configuration depicted in FIG. 14a is also a special case of that in FIG. 11, in which (1) the number of elements, N, is set to 4, (2) the transmitting elements 434 are not identical, and (3) 2 of the selected elements feature low gain broad beams and the remaining two are high gain shaped beams oriented to various directions.

### REFERENCES

1. “MIMO-OFDM Wireless Systems: Basics, Perspectives, and Challenges,” by Helmut Bölcskei, Eth Zurich; IEEE Wireless Communications, August 2006.
2. “Multiuser MIMO-OFDM for Next-Generation Wireless Systems,” by Ming Jiang, and Lajos Hanzo, Proceedings of the IEEE | Vol. 95, No. 7, July 2007.
3. U.S. Pat. No. 7,324,480; “Mobile Communications Apparatus and Methods including base-station and Mobile station having multi-antennas;” by S. J. Kim and et al; issued on Jan. 29, 2008.
4. “A Survey on the Successive Interference Cancellation Performance for OFDM Systems,” by N. I. Miridakis And D. D. Vergados; IEEE Communications Surveys & Tutorials, Vol. 15, No. 1, First Quarter 2013.
5. U.S. Pat. No. 8,111,646; “Communications Systems for Dynamically Combing power from a Plurality of Propagation Channels in order to Improve Power Levels of Transmitted Signals without Affecting Receiver and Propagation Segments,” by D C D Chang; issued on Feb. 7, 2012.
6. “Improving MU-MIMO Performance in LTE-(Advanced) by Efficiently Exploiting Feedback Resources and through Dynamic Scheduling,” by Ankit Bhamri et al, WCNC 2013, IEEE Wireless Communications and Networking Conference, Apr. 7-10, 2013, Shanghai, China.
7. “A Simple Transmit Diversity Technique for Wireless Communications,” Siavash M. Alamouti IEEE Journal on Select Areas in Communications, Vol. 16, No. 8, October 1998 p1451-p1458.

What is claimed is:

1. A multi-user (MU) multiple-input-and-multiple-output (MIMO) communications system through a multiple path dominant channel, is configured to operate as a point-to-multipoint (p-to-mp) communication network comprising
a transmitter with N radiating elements in a serving hub is configured to send different sets of information independently to at least two spatially separated users multiple shaped transmitting beams in a common frequency slot;
wherein each of the shaped transmitting beams is further configured with concurrent and discriminative performance constraints favoring one user and discriminating all other users
a first set of user equipment (UE) with multiple receiving elements for a first user in a first destination in a common service region, wherein the first set of UE is configured to receive a first set of information sent by the transmitter, and
a second set of user equipment (UE) with multiple receiving elements for a second user in a second destination in the common service region, wherein the second set of UE is configured to receive a second set of information sent by the transmitter.

2. The MU MIMO communications system of claim 1, wherein the transmitter further comprising a beam shaping preprocessor for the transmitting beams by optimizing composited transfer functions (CTFs) under concurrent performance constraints of user indexed performance criteria; wherein the concurrent performance constraints are configured to favor one of the users while discriminating against all others.

3. The CTFs in the communications system of claim 2, wherein each of the CTFs is a weighted sum of radiation patterns of N transmitting elements as a radiation pattern of a shaped beam generated by a 1-to-N transmitting beam-forming processor;

4. The communications system of claim 1, the transmitter is further configured to calculate and optimize the shaped beams based on current channel state information (CSI) derived from received feedback data from at least the two sets of user equipment (UE) from the two users accordingly.

5. The transmitter in claim 4 is further configured to dynamically update current channel state information (CSI).

6. The communications system of claim 1, wherein the transmitter in the serving hub further comprising multiple antenna elements connected by beam forming networks (BFN); wherein the BFNs are configured for altering shapes of transmit beams via updating amplitude and phase weightings on antenna elements;

7. The beam forming networks of claim 6, where shapes of transmitting beams are dynamically configured by altering beam weight vectors (BWV) in digital beam forming (DBF) processors.

8. The communications system of claim 1, wherein the transmitter in the serving hub further comprising comprise re-configurable beam-forming-networks (BFN) for high gain transmitting antennas; wherein the BFNs configured for altering shapes of transmit beams under concurrent and discriminative performance constraints.

9. The communications system of claim 1, wherein the transmitter in the serving hub further comprising comprise high gain transmitting reflector antennas with re-configurable surface; wherein the reflector antennas are configured for altering shapes of transmit beams via updating surface mechanical shapes of the reflector antennas according to concurrent and discriminative performance criteria.

10. The communications system of claim 1, the concurrent performance criteria comprise orthogonal beam (OB) constraints of maximized intensities for a signal stream of a composited function on a first set of propagation paths for desired users, and nulls with zero intensities for the same signal stream of the composited function on a second set of propagation paths for undesired users.

11. The communications system of claim 1, the concurrent performance criteria comprise quiet-zone constraints with two intensity thresholds, a first intensity threshold I1 and a second intensity threshold I2,
wherein the first intensity threshold I1 is adapted to be at least 35 dB greater than the second intensity threshold I2;
wherein the first intensity threshold I1 is adapted to be lower than intensities of a composited function for a signal stream on a first set of propagation paths for desired users, and
wherein the second intensity threshold I2 is adapted to be higher than intensities of the composited function for the same signal stream on a second set of propagation paths for undesired users.

12. The communications system of claim 1, the transmitter is further configured to optimize shaped beams under concurrent discriminative performance constraints via iterative techniques;

13. The communications system of claim 1, wherein the transmitter at the serving hub further comprising at least a wavefront multiplexing (WF muxing) transform.

14. A MU MIMI communications system through a multiple path dominant channel, is configured to operate as a point-to-multipoint (p-to-mp) communication network comprising
a transmitter with N radiating elements in a serving hub is configured to send different sets of information independently to at least two spatially separated users multiple shaped transmitting beams in a common frequency slot;
wherein a transmitter is configured to generate composited transfer functions (CTFs),
wherein the composited transfer functions (CTF) are further configured to meet user indexed performance constraints concurrently specified at least by two independent linear combinations of multiple point-to-point (p-to-p) transfer functions;
and
a first set of user equipment (UE) with multiple receiving elements for a first user in a first destination in a common service region, wherein the first set of UE is configured to receive a first set of information sent by the transmitter,

15. The communications system of claim 14, wherein the composited transfer functions (CTF) are further configured to meet a user indexed performance constraint concurrently specified at least by a weighted sum of two independent point-to-point (p-to-p) transfer functions for various transmitting antenna elements to a common receiving element in user equipment (UE).

16. The communications system of claim 14, wherein the composited transfer functions further comprising multiple weighted sums of at least two independent point-to-point (p-to-p) transfer functions for transmitting antenna elements to a common receiving element in user equipment (UE); wherein weighting parameters for the weighted sum are further optimized under multiple user indexed performance constraints;

17. The communications system of claim 14, the user indexed performance criteria comprise orthogonal beam (OB) constraints of maximized intensities of a signal stream in a composited function on a first set of user indexed propagation paths for desired users, and nulls with zero intensities of the same signal stream in the composited function on a second set of user indexed propagation paths for undesired users.

18. The communications system of claim 14, the user indexed performance criteria comprise quiet-zone constraints with two intensity thresholds, a first intensity threshold I1 and a second intensity threshold I2,
wherein the first intensity threshold I1 is adapted to be at least 35 dB greater than the second intensity threshold I2;
wherein the first intensity threshold I1 is adapted to be lower than intensities of a signal stream in a composited function on a first set of user indexed propagation paths for desired users, and
wherein the second intensity threshold I2 is adapted to be higher than intensities of the signal stream in the composited function on a second set of user indexed propagation paths for undesired users.

19. The communications system of claim 14, the transmitter is configured to use optimization loops for beam shaping under user indexed constraints via iterative techniques;

20. The communications system of claim 14, wherein the transmitter at the serving hub further comprising comprise at least a wavefront multiplexing (WF muxing) transform.
